(19) United States
(12) Patent Application Publication
(10) Pub. No.: US 2007/0092171 A1
(43) Pub. Date: Apr. 26, 2007

(54) Hydrodynamic bearing device and manufacturing method thereof

(76) Inventors: Takafumi Asada, Osaka (JP); Tsutomu Hamada, Osaka (JP); Masato Morimoto, Osaka (JP); Katsuo Ishikawa, Ehime (JP)

Correspondence Address: WENDEROTH, LIND & PONACK L.L.P., 2033 K. STREET, NW, SUITE 800, WASHINGTON, DC, 20006, US

(21) Appl. No.: 11/521,362

(22) Filed: Sep. 15, 2006

(30) Foreign Application Priority Data
Oct. 21, 2005 (JP) 2005-306922
Oct. 21, 2005 (JP) 2005-307089

(51) Int. Cl. F16C 32/06

(52) U.S. Cl. 384/107

(57) ABSTRACT

A hydrodynamic bearing having a high performance and a long life and a manufacturing method for the same are provided by forming hydrodynamic grooves to have a sufficient depth with a high accuracy, and sealing remaining pores on a bearing surface. A shaft is inserted into a bearing hole of a sleeve so as to be relatively rotatable. The bearing hole has a bearing surface having hydrodynamic grooves. The sleeve is formed by: forming metal powder to have a hollow cylindrical shape, sintering the metal powder; inserting a core rod in a pattern having a tapered surface into a bore of the sintered metal material; forming an inner surface having hydrodynamic grooves by pressing the sintered metal material from upper, lower and outer peripheral direction; inserting a core rod having a wide diameter portion and a narrow diameter portion into the bore of the sintered metal material to form the bearing bore surface of a hydrodynamic groove with the small diameter portion and to form the sleeve inner surface with the wide diameter portion at the same time; and removing the core rod from bore of the sintered metal material to have the inner periphery formed as such as the bearing inner surface and a large diameter portion as a lubricating fluid reservoir. Thus, grooves can be processed with a high accuracy.

### TECHNICAL FIELD

The present invention relates to a hydrodynamic bearing device using a hydrodynamic bearing.

### BACKGROUND ART

In recent years, recording devices and the like using discs to be rotated experience an increase in a memory capacity and an increase in a transfer rate for data. Thus, bearings used for such recording devices are required to have high performance and high reliability to constantly rotate a disc with a high accuracy. Accordingly, hydrodynamic bearing devices suitable for high-speed rotation are used for such rotary devices.

A hydrodynamic bearing device has a lubricating fluid (in general, oil, but highly fluidic grease or ionic liquids have similar effects) interposed between a shaft and a sleeve, and generates a pumping pressure by hydrodynamic grooves during rotation. Thus, the shaft rotates in a non-contact state with respect to the sleeve. Because of this rotation in the non-contact state, no mechanical friction is generated. Thus, the hydrodynamic bearing device is suitable for high-speed rotation.

Hereinafter, an example of conventional hydrodynamic bearing devices will be described with reference to FIGS. 18 through 28.

FIG. 18 is a cross-sectional view schematically showing a structure of a conventional hydrodynamic bearing device. As shown in FIG. 18, the hydrodynamic bearing device includes a shaft 31, a flange 32, a sleeve 33, a thrust plate 34, a sleeve cover 35, a lubricating fluid 36, a rotor 37, a disc 38, a rotor magnet 39, a stator 41, and a base 41. The shaft 31 is formed integrally with a flange 32. The shaft 31 is inserted into a bearing hole 33A of the sleeve 33 so as to be rotatable. The flange 32 is accommodated within sleeve cover 35 on a lower surface of the sleeve 33. On at least one of an outer peripheral surface of the shaft 31 and an inner peripheral surface of the sleeve 33, hydrodynamic groove 33B and 33C are formed. On a surface of the flange 32 which opposes the sleeve 33 and on a surface of the flange 32 which opposes the thrust plate 34, hydrodynamic grooves 32A and 32B are formed. The thrust plate 34 is fixed to the sleeve cover 35. Bearing gaps near the hydrodynamic grooves 33B, 33C, 32A, and 32B are filled with at least the lubricating fluid 36. The rotor 37 is fixed to the shaft 31. The disc 38 is fixed to the rotor 37 by a damper or the like (not shown). The sleeve 33 is formed of a metal sintered body. Pores remain inside the metal sintered body. The lubricating fluid 36 are injected into the pores. Then, the sleeve 33 is lightly press-fitted to the sleeve cover 35 such that the sleeve cover 35 covers the porous sleeve 33 entirely. In this way, the lubricating fluid 36 is prevented from flowing out from the pores on the surface of the sleeve 33 to avoid insufficiency of the lubricating fluid in the sleeve 33, and also, the lubricating fluid 36 flown out is prevented from gasifying and contaminating the surroundings of the hydrodynamic bearing device. The sleeve cover 35 is fixed to the base 41. The rotor magnet 39 is fixed to the rotor 37. Further, the base 41 has a motor stator 40 fixed to a position opposing the rotor magnet 39.

An operation of the conventional hydrodynamic bearing device having the above-described structure will be described. As shown in FIG. 18, when a rotational magnetic field is generated at the stator 40 by an electronic circuit (not shown), a rotational force is applied to the rotor magnet 39, and the rotor 37, the shaft 31, the flange 32, and the disc 38 start to rotate. When the rotor 37, the shaft 31, the flange 32, and the disc 38 rotates, the hydrodynamic grooves 33B, 33C, 32A, and 32B gather the lubricating fluid 36, and generate pumping pressures between the shaft 31 and the sleeve 33, between the flange 32 and the sleeve 33, and between the flange 32 and the thrust plate 34. In this way, the shaft 31 can rotate in a non-contact state with respect to the sleeve 33 and the thrust plate 34 and data can be recorded/reproduced on/from the disc 38 by a magnetic head or an optical head (not shown). In a conventional hydrodynamic bearing device, the sleeve 33 is formed of a metal sintered body of copper alloy, which is an inexpensive material having a rust-resistant effect.

Hereinafter, a conventional manufacturing method of the sleeve 33 will be described with reference to FIGS. 19 through 28.

FIG. 19 shows a schematic example of a molding device for manufacturing the sleeve 33 shown in FIG. 18 by processing the bearing hole 33A and the hydrodynamic grooves 33B and 33C on a sintered metal material 46 which has been previously prepared. As shown in FIG. 19, the molding device includes a lower mold 42, an upper mold 43, a core rod 44 and an outer mold 45. The outer mold 45 is provided coaxially on an outer surface of the upper mold 43 so as to be slidable. The core rod 44 is provided coaxially on an inner surface of the upper mold 43 so as to be slidable. On an outer surface 44A of the core rod 44, recessed portions 44B and 44C of a herringbone pattern are processed to have a uniform depth by using an etching machining method, shot peening method, or the like.

In the conventional method for manufacturing the sleeve 33, the sintered metal material 46 is set on the lower mold 42 as shown in FIG. 19. Next, the upper mold 43 is moved downward as indicated by arrows in FIG. 20 to abut the sintered metal material 46. Then, as shown in FIG. 20, the core rod 44 is inserted to a bore of the sintered metal material 46. Thereafter, the outer mold 45 is moved downward as indicated by arrows in FIG. 20. As shown in FIG. 21, when the outer mold 45 is moved downward, it squeezes the sintered metal material 46 with a pressure being applied to an external surface of the sintered metal material 46 from an inner surface of the outer mold 45. In this way, as shown in FIG. 22, the sintered metal material 46 experiences a plastic flow, and flows into the recessed portions 44B and 44C of the core rod 44 to engage the recessed portions 44B and 44C. Next, the outer mold 45 is moved upward as indicated by arrows in FIG. 23, and the inner and outer diameters of the sintered metal material 46 expand respectively by about 2 micrometers due to a springback property. Then, the upper mold 43 is moved upward as indicated by arrows in FIG. 24, and the sintered metal material 46 is removed from the molding device. Processing of the bearing hole 33A and the hydrodynamic grooves 33B and 33C on the sintered metal material 46 is completed, and the sleeve 33 shown in FIG. 24 is formed.

Note that FIGS. 18 to 28 used for explaining of conventional hydrodynamic bearing device and a method of manufacturing the same are not prior arts but merely comparative examples.

### DISCLOSURE OF THE INVENTION

### Problems to be Solved by the Invention

In the above conventional hydrodynamic bearing device, the sleeve 33 engaging the core rod 44 is detached by utilizing the springback property as shown in FIGS. 23 and 24. Since the springback property is insufficient such that the inner diameter of the sleeve 33 expands by only about 2 micrometers, the depth of the hydrodynamic grooves 33B and 33C is shallow and is about 1 micrometer as shown in FIG. 25. As shown in FIG. 28, such a shallow groove can only provide about 30% of a required pressure to be generated in the hydrodynamic bearing device shown in FIG. 18. Thus, the performance and the reliability as the hydrodynamic bearing device are poor.

In order to have deep hydrodynamic grooves 33B and 33C, for example, to have the depth of about 5 micrometers, the recessed portions 44B and 44C having the herringbone pattern of the core rod 44 can be processed to be deeper. In such a case, since an amount of the springback of the sintered metal material 46 is insufficient, the core rod 44 has to be removed forcibly. Thus, as shown in FIG. 26, the hydrodynamic grooves 33B and 33C and the recessed portions 44B and 44C having the herringbone pattern of the core rod 44 interfere each other. As a result, as shown in FIG. 27, the shape of the hydrodynamic grooves 33B and 33C is deformed. Therefore, in the conventional hydrodynamic bearing device, a sufficient dynamic pressure cannot be generated. When such a hydrodynamic bearing device is rotated continuously at a high speed for a long period of time under a high temperature condition, the rotary device may start to rub in a short period of time. As a result, heat is produced and the lubricating fluid 36 is gasified. Or, the bearing may rub.

Further, the sleeve 33 formed of a metal sintered body is porous. Under the general manufacturing conditions, 2% or more pores remain on a surface. Thus, even when the hydrodynamic grooves 33B, 33C, 32A, and 32B gather the lubricating fluid 36 by rotation, and generate pumping pressures between the shaft 31 and the sleeve 33, between the flange 32 and the sleeve 33, and between the flange 32 and the thrust plate 34 as shown in FIG. 18, about 30% of the generated pressures are released from the pores on the surface. This causes that a required pressure is not obtained on an inner peripheral surface of the bearing. When the hydrodynamic bearing device is used under a condition such as a high temperature and the viscosity of the lubricating fluid 36 is lowered, or the hydrodynamic bearing device is used under a condition of a heavy load such as the disc 38, the shaft 31 cannot be lifted with respect to the sleeve 33 and the thrust plate 34. They may contact each other and produce heat or rub each other.

An object of the present invention is to provide a hydrodynamic bearing device which can solve a problem of a deteriorating performance due to pressure leakage from a bearing surface of a sleeve, improve durability and rotation accuracy of the hydrodynamic bearing device, and also reduce the cost by securing a depth and an accuracy of a surface configuration (configuration accuracy) of hydrodynamic grooves on the sleeve formed of a sintered metal body, which cannot be achieved sufficiently by the above conventional hydrodynamic bearing device.

### Means for Solving the Problems

A hydrodynamic bearing device of the first invention comprises a shaft, a sleeve and a lubricating fluid. The sleeve has a bearing hole with the shaft being inserted into the bearing hole so as to be relatively rotatable. Further, the sleeve is formed of sintered metal. The lubricating fluid is held between the shaft and the sleeve. On an inner peripheral surface of the bearing hole, a second groove which forms a lubricating fluid reservoir, and a first groove which forms a hydrodynamic portion having a depth greater than that of the second groove and a cross section of a substantially trapezoidal shape are formed.

With such a structure, a depth of the hydrodynamic grooves and accuracy of the surface configuration (configuration accuracy) can be secured. Thus, the shaft can be lifted with respect to the sleeve and the thrust plate in a stable manner. As a result, durability, rotation accuracy can be improved while the cost can be reduced in the hydrodynamic bearing device.

A hydrodynamic bearing device of the second invention is a hydrodynamic bearing device of the first invention in which a surface of the sleeve is impregnated with a resin or water glass to seal pores on the surface.

With such a structure, the pores on the surface of the sleeve can be completely sealed. Thus, a sleeve cover required in a conventional hydrodynamic bearing device is no longer necessary. Further, insufficiency of the lubricating fluid inside the sleeve caused by the lubricating fluid flowing out from the surface pores and contamination of the surroundings of the hydrodynamic bearing caused by gasification of the flown out lubricating fluid can be prevented.

A hydrodynamic bearing device of the third invention is a hydrodynamic bearing device of the first invention in which a surface of the sleeve is impregnated with metal molten by heating to seal pores on the surface.

With such a structure, the pores on the surface of the sleeve can be completely sealed. Thus, a sleeve cover required in a conventional hydrodynamic bearing device is no longer necessary. Further, insufficiency of the lubricating fluid inside the sleeve caused by the lubricating fluid flowing out from the surface pores and contamination of the surroundings of a hydrodynamic bearing caused by gasification of the flown out lubricating fluid can be prevented.

A hydrodynamic bearing device of the fourth invention is a hydrodynamic bearing device of the first invention in which an oxide film is formed on a surface of the sleeve to seal pores on the surface.

With such a structure, the pores on the surface of the sleeve can be completely sealed. Thus, a sleeve cover required in a conventional hydrodynamic bearing device is no longer necessary. Further, insufficiency of the lubricating fluid inside the sleeve caused by the lubricating fluid flowing out from the surface pores and contamination of the surroundings of a hydrodynamic bearing caused by gasification of the flown out lubricating fluid can be prevented.

A hydrodynamic bearing device of the fifth invention is a hydrodynamic bearing device of the first invention in which a thin film is formed on a surface of the sleeve by plating metal including nickel.

With such a structure, a hardness of the surface of the sleeve can be improved compared to that of the inside.

A hydrodynamic bearing device of the sixth invention is a hydrodynamic bearing device of the first invention in which a thin film is formed a surface of the sleeve by DLC coating.

With such a structure, a hardness of the surface of the sleeve can be improved compared to that of the inside.

A spindle motor of the seventh invention comprises a hydrodynamic bearing device of the first invention, a hub, a magnet, a base plate, and a stator. The hub is fixed to a hydrodynamic bearing, and allows the hydrodynamic bearing to rotate. The magnet is fixed to the hub. The base plate fixed the hydrodynamic bearing. The stator is fixed to the base plate so as to oppose the magnet.

With such a structure, the shaft can be lifted with respect to the sleeve and the thrust plate in a stable manner. As a result, a spindle motor having a hydrodynamic bearing with high performance and reliability can be provided.

A method for manufacturing a hydrodynamic bearing device of the eighth invention is a method for manufacturing a hydrodynamic bearing device having a shaft, a bearing hole having a hydrodynamic groove on an inner peripheral surface, and a sleeve having the shaft inserted into the bearing hole so as to be relatively rotatable, comprising first through fourth steps. The first step is a step for forming a first compact (metal material) by forming metal powder to have a hollow cylindrical shape. The second step is a step for sintering the first compact (metal material). The third step is a step for inserting a first core rod having a tapered surface and recessed portions in a pattern on the tapered surface into a bore of a second compact obtained by sintering at the second step, forming hydrodynamic grooves with the recessed portions formed on the tapered surface by pressing from upper, lower and side surfaces, and removing the first core rod to form a half-finished sleeve with the hydrodynamic grooves. The fourth step is a step for inserting a second core rod having a wide diameter portion and a narrow diameter portion into the half-finished sleeve, and pressing from upper, lower and side surfaces to form a bearing inner surface having a hydrodynamic groove, which is a first groove, with the small diameter portion of the second core rod, forming a second groove of a large diameter portion on the inner peripheral surface of the sleeve with the wide diameter portion of the second core rod, and removing the second core rod to form the sleeve.

With such a structure, a depth of the hydrodynamic grooves and accuracy of the surface configuration (configuration accuracy) can be secured. Further, pores remaining of the surface of the inner peripheral surface of the bearing are eliminated to have a dense surface. The pressures generated at the hydrodynamic grooves are prevented from being released. As a result, a high pressure can be generated on the hydrodynamic bearing surface. Thus, the shaft can be lifted with respect to the sleeve and the thrust plate in a stable manner, and the performance and the reliability of the hydrodynamic bearing can be improved.

A method for manufacturing a hydrodynamic bearing device of the ninth invention is a method for manufacturing a hydrodynamic bearing device of the eighth invention in which the tapered surface of the second core rod has a tapered angle of 1 to 3 degrees.

With such a structure, the core rod can be removed smoothly in a upward direction.

A method for manufacturing a hydrodynamic bearing device of the tenth invention is a method for manufacturing a hydrodynamic bearing device of the eighth invention further comprising a fifth step for sealing a surface of the sleeve with at least one of the following methods: impregnating the surface of the sleeve with a resin or water glass, impregnating metal molten by heating; or forming an oxide film on the surface of the sleeve.

With such a structure, a processing accuracy of the hydrodynamic grooves can be improved.

A method for manufacturing a hydrodynamic bearing device of the eleventh invention is method for manufacturing a hydrodynamic bearing device of the eighth invention further comprising a sixth step for forming a thin film by plating metal including nickel or by DLC coating on a surface of the sleeve.

With such a structure, a surface hardness of the sleeve can be improved compared to the inside, and abrasion resistant property and the reliability can be improved.

A hydrodynamic bearing device of the twelfth invention comprises a shaft, a sleeve, and a lubricating fluid. The sleeve has a bearing hole with the shaft being inserted into the bearing hole so as to be relatively rotatable. Further, the sleeve is formed of sintered metal. The lubricating fluid is held between the shaft and the sleeve. On an inner peripheral surface of the bearing hole, a second groove which forms a lubricating fluid reservoir, and a first groove which forms a hydrodynamic portion having a depth greater than that of the second groove and a cross section of a substantially arc shape are formed.

With such a structure, a depth of the hydrodynamic grooves and accuracy of the surface configuration (configuration accuracy) can be secured. Thus, the shaft can be lifted with respect to the sleeve and the thrust plate in a stable manner. As a result, durability, rotation accuracy can be improved while the cost can be reduced in the hydrodynamic bearing device.

A hydrodynamic bearing device of the thirteenth invention is a hydrodynamic bearing device of the twelfth invention in which a surface of the sleeve is impregnated with a resin or water glass to seal pores on the surface.

With such a structure, the pores on the surface of the sleeve can be completely sealed. Thus, a sleeve cover required in a conventional hydrodynamic bearing device is no longer necessary. Further, insufficiency of the lubricating fluid inside the sleeve caused by the lubricating fluid flowing out from the surface pores and contamination of the surroundings of a hydrodynamic bearing caused by gasification of the flown out lubricating fluid can be prevented.

A hydrodynamic bearing device of the fourteenth invention is a hydrodynamic bearing device of the twelfth invention in which a surface of the sleeve is impregnated with metal molten by heating to seal pores on the surface.

With such a structure, the pores on the surface of the sleeve can be completely sealed. Thus, a sleeve cover required in a conventional hydrodynamic bearing device is no longer necessary. Further, insufficiency of the lubricating fluid inside the sleeve caused by the lubricating fluid flowing out from the surface pores and contamination of the surroundings of a hydrodynamic bearing caused by gasification of the flown out lubricating fluid can be prevented.

A hydrodynamic bearing device of the fifteenth invention is a hydrodynamic bearing device of the twelfth invention in which an oxide film is formed on a surface of the sleeve to seal pores on the surface.

With such a structure, the pores on the surface of the sleeve can be completely sealed. Thus, a sleeve cover required in a conventional hydrodynamic bearing device is no longer necessary. Further, insufficiency of the lubricating fluid inside the sleeve caused by the lubricating fluid flowing out from the surface pores and contamination of the surroundings of a hydrodynamic bearing caused by gasification of the flown out lubricating fluid can be prevented.

A hydrodynamic bearing device of the sixteenth invention is a hydrodynamic bearing device of the twelfth invention in which a thin film is formed on a surface of the sleeve by plating metal including nickel.

With such a structure, a hardness of the surface of the sleeve can be improved compared to that of the inside.

A hydrodynamic bearing device of the seventeenth invention is a hydrodynamic bearing device of the twelfth invention in which a thin film is formed a surface of the sleeve by DLC coating.

With such a structure, a hardness of the surface of the sleeve can be improved compared to that of the inside.

A spindle motor of the eighteenth invention comprises a hydrodynamic bearing device of the first invention, a hub, a magnet, a base plate, and a stator. The hub is fixed to a hydrodynamic bearing, and allows the hydrodynamic bearing to rotate. The magnet is fixed to the hub. The base plate fixed the hydrodynamic bearing. The stator is fixed to the base plate so as to oppose the magnet.

With such a structure, the shaft can be lifted with respect to the sleeve and the thrust plate in a stable manner. As a result, a spindle motor having a hydrodynamic bearing with high performance and reliability can be provided.

A method for manufacturing a hydrodynamic bearing device of the nineteenth invention is a method for manufacturing a hydrodynamic bearing device having a shaft, a bearing hole having a hydrodynamic groove on an inner peripheral surface, and a sleeve having the shaft inserted into the bearing hole so as to be relatively rotatable, comprising first through fourth steps. The first step is a step for forming a first compact (metal material) by forming metal powder to have a hollow cylindrical shape. The second step is a step for sintering the first compact (metal material). The third step is a step for forming first groove of the hydrodynamic groove on the inner peripheral surface of a second compact obtained by sintering at the second step. The fourth step is a step for inserting a core rod having a wide diameter portion and a narrow diameter portion into the second compact, and pressing from upper, lower and side surfaces to form a bearing inner surface having a hydrodynamic groove with the small diameter portion of the core rod, forming a second groove of a large diameter portion on the inner peripheral surface of the sleeve with the wide diameter portion of the core rod, and removing the second core rod to form the sleeve.

With such a structure, a depth of the hydrodynamic grooves and accuracy of the surface configuration (configuration accuracy) can be secured. Further, pores remaining of the surface of the inner peripheral surface of the bearing are eliminated to have a dense surface. The pressures generated at the hydrodynamic grooves are prevented from being released. As a result, a high pressure can be generated on the hydrodynamic bearing surface. Thus, the shaft can be lifted with respect to the sleeve and the thrust plate in a stable manner, and the performance and the reliability of the hydrodynamic bearing can be improved.

A method for manufacturing a hydrodynamic bearing device of the twentieth invention is a method for manufacturing a hydrodynamic bearing device of the nineteenth invention further comprising a fifth step for sealing a surface of the sleeve with at least one of the following methods: impregnating the surface of the sleeve with a resin or water glass, impregnating metal molten by heating; or forming an oxide film on the surface of the sleeve.

With such a structure, a processing accuracy of the hydrodynamic grooves can be improved.

A method for manufacturing a hydrodynamic bearing device of the twenty-first invention is method for manufacturing a hydrodynamic bearing device of the nineteenth invention further comprising a sixth step for forming a thin film by plating metal including nickel or by DLC coating on a surface of the sleeve.

With such a structure, a surface hardness of the sleeve can be improved compared to the inside, and abrasion resistant property and the reliability can be improved.

### Effects of the Invention

According to the hydrodynamic bearing device of the present invention, a depth of the hydrodynamic grooves and accuracy of the surface configuration (configuration accuracy) can be secured. Further, pores remaining of the surface of the inner peripheral surface of the bearing are eliminated to have a dense surface. The pressures generated at the hydrodynamic grooves are prevented from being released. Thus, a high pressure can be generated on the hydrodynamic bearing surface. As a result, durability, rotation accuracy can be improved while the cost can be reduced in the hydrodynamic bearing device.

### BRIEF DESCRIPTION OF THE DRAWINGS

FIG. 1 is a cross-sectional view of a hydrodynamic bearing device according to Embodiment 1 of the present invention.

FIG. 2 is a detailed cross-sectional view of a sleeve in the hydrodynamic bearing device of FIG. 1.

FIG. 3 is a cross-sectional view of a first sizing metal mold in the hydrodynamic bearing device of FIG. 1.

FIGS. 4A and 4B are cross-sectional views of a second sizing metal mold in the hydrodynamic bearing device of FIG. 1.

FIG. 5 is a cross-sectional view of the second sizing metal mold in the hydrodynamic bearing device of FIG. 1.

FIG. 6 is a cross-sectional view of the second sizing metal mold in the hydrodynamic bearing device of FIG. 1.

FIG. 7 is a cross-sectional view of the second sizing metal mold in the hydrodynamic bearing device of FIG. 1.

FIG. 8 is a cross-sectional view of the second sizing metal mold in the hydrodynamic bearing device of FIG. 1.

FIG. 9 is a cross-sectional view of the second sizing metal mold in the hydrodynamic bearing device of FIG. 1.

FIG. 10 is a cross-sectional view of a third sizing metal mold in the hydrodynamic bearing device of FIG. 1.

FIG. 11 is a cross-sectional view of the third sizing metal mold in the hydrodynamic bearing device of FIG. 1.

FIG. 12 is a cross-sectional view of the third sizing metal mold in the hydrodynamic bearing device of FIG. 1.

FIG. 13 is a diagram illustrating a tapered angle and a load in the hydrodynamic bearing device of FIG. 1.

FIG. 14 is a cross-sectional view of the sleeve in the hydrodynamic bearing device of FIG. 1.

FIG. 15 is a partial cross-sectional view of the sleeve in the hydrodynamic bearing device of FIG. 1.

FIG. 16 is a diagram illustrating a bearing life of the hydrodynamic bearing device of FIG. 1.

FIG. 17 is a cross-sectional view of a hydrodynamic bearing device according to Embodiment 3 of the present invention.

FIG. 18 is a cross-sectional view of a conventional hydrodynamic bearing device.

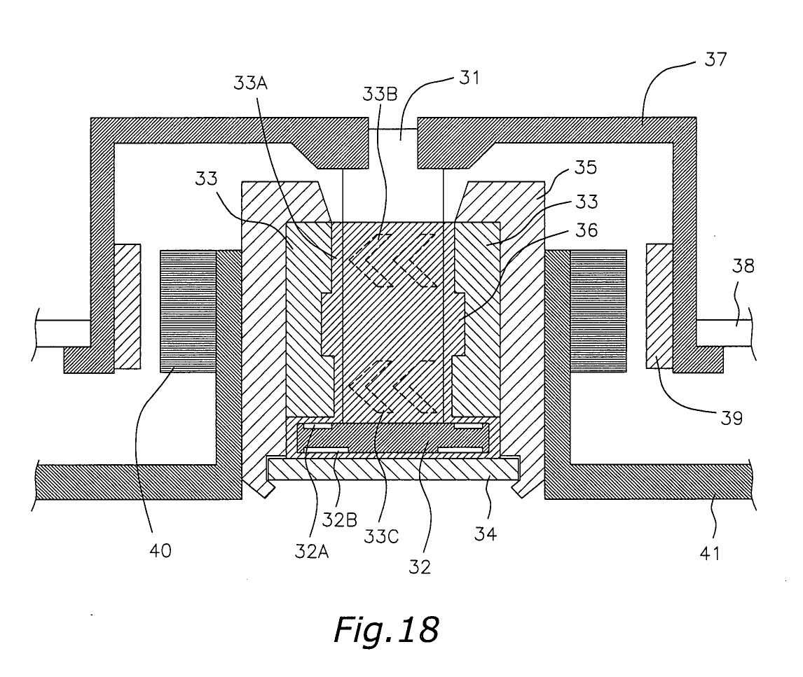

FIG. 19 is a cross-sectional view of a molding device for the sleeve in the conventional hydrodynamic bearing device.

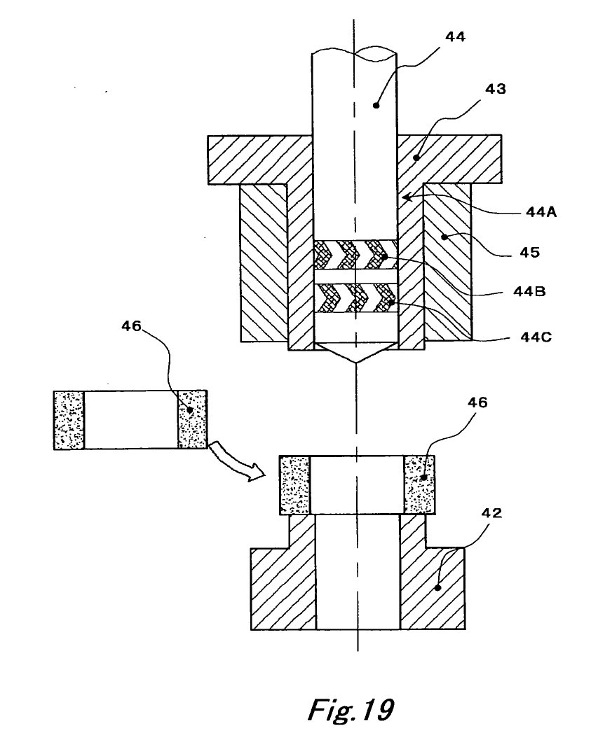

FIG. 20 is a cross-sectional view of the molding device for the sleeve in the conventional hydrodynamic bearing device.

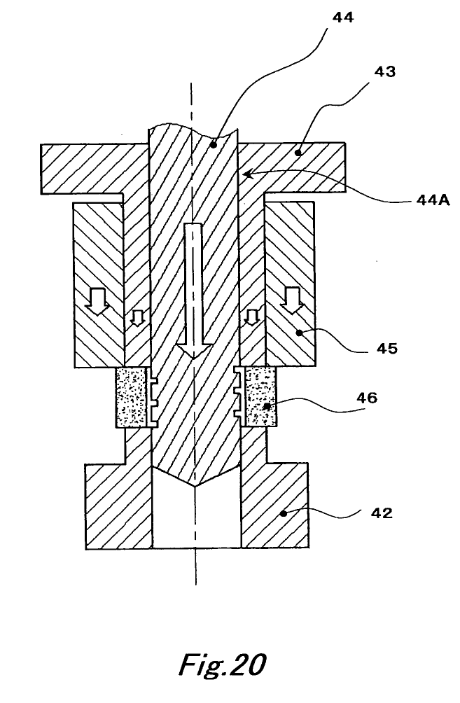

FIG. 21 is a cross-sectional view of the molding device for the sleeve in the conventional hydrodynamic bearing device.

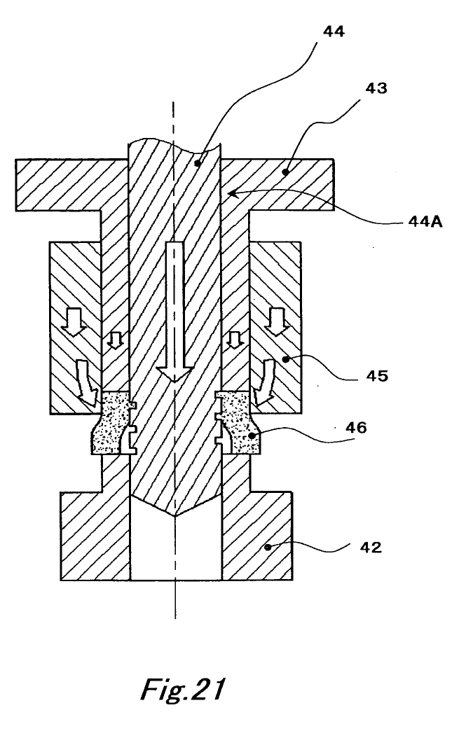

FIG. 22 is a cross-sectional view of the molding device for the sleeve in the conventional hydrodynamic bearing device.

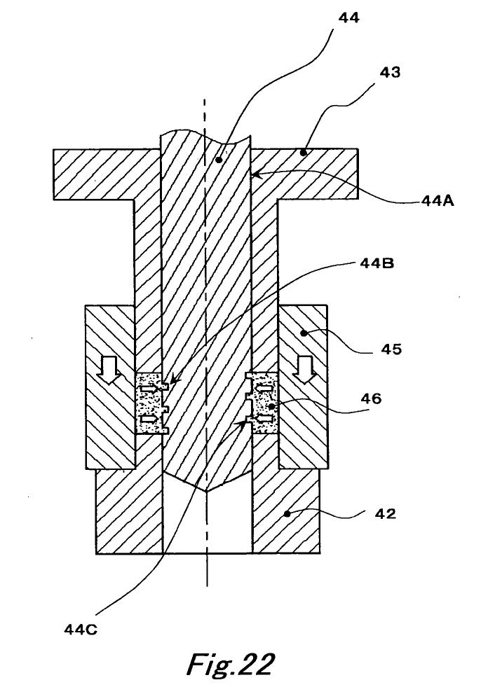

FIG. 23 is a cross-sectional view of the molding device for the sleeve in the conventional hydrodynamic bearing device.

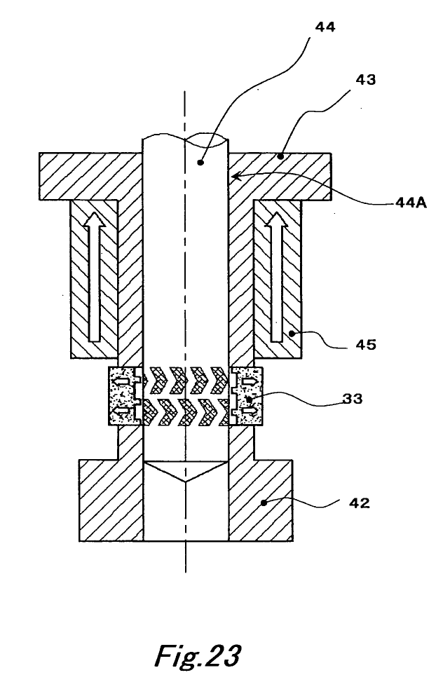

FIG. 24 is a cross-sectional view of the molding device for the sleeve in the conventional hydrodynamic bearing device.

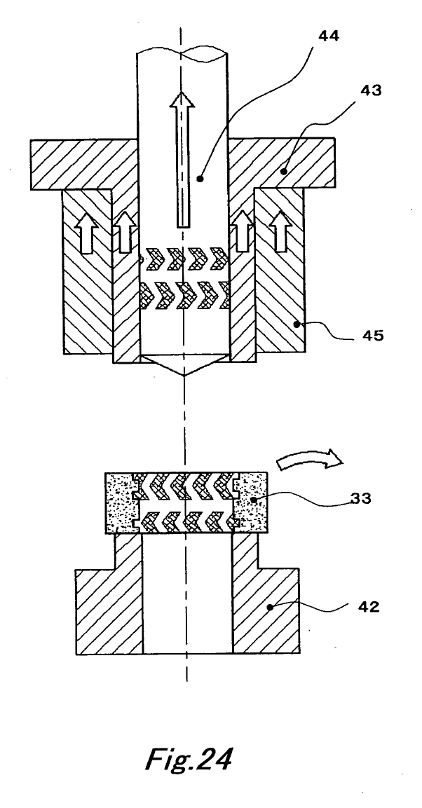

FIG. 25 is a partial cross-sectional view of the sleeve in the conventional hydrodynamic bearing device.

FIG. 26 is a diagram illustrating a core rod in the conventional hydrodynamic bearing device.

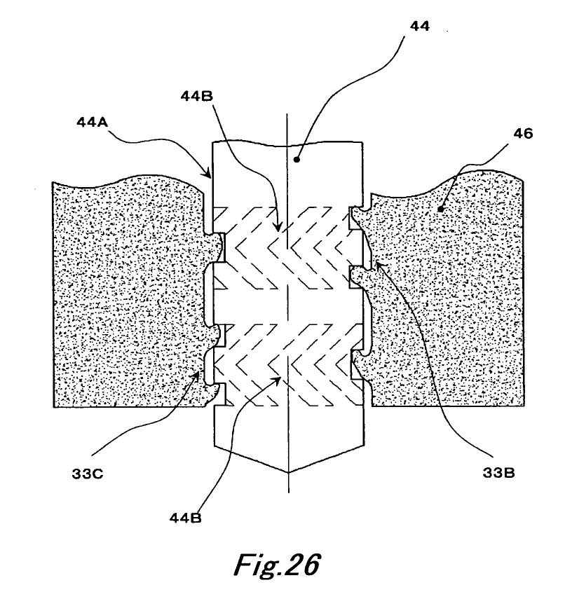

FIG. 27 is a partial cross-sectional view of the sleeve in the conventional hydrodynamic bearing device.

FIG. 28 is a diagram illustrating a pump pressure of the conventional hydrodynamic bearing device.

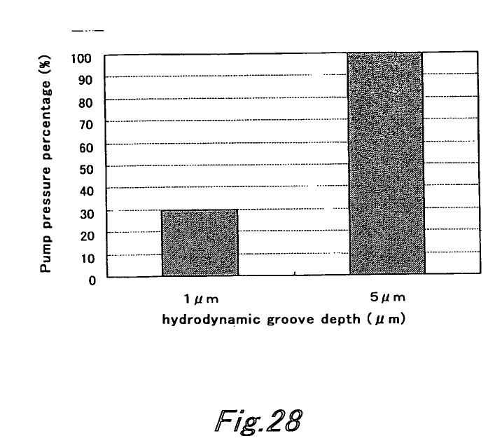

FIG. 29 is a cross-sectional view of a fourth sizing metal mold in the hydrodynamic bearing device of FIG. 1.

FIG. 30 is a cross-sectional view of a hydrodynamic groove rolling device in the hydrodynamic bearing device of FIG. 1.

FIG. 31 is a cross-sectional diagram of a sintered metal body in the hydrodynamic bearing device of FIG. 1.

FIG. 32 is a partial cross-sectional view of the sintered metal body in the hydrodynamic bearing device of FIG. 1.

FIG. 33 is a cross-sectional view of a fifth sizing metal mold in the hydrodynamic bearing device of FIG. 1.

FIG. 34 is a cross-sectional view of the fifth sizing metal mold in the hydrodynamic bearing device of FIG. 1.

FIG. 35 is a cross-sectional view of the fifth sizing metal mold in the hydrodynamic bearing device of FIG. 1.

FIG. 36 is a cross-sectional view of the fifth sizing metal mold in the hydrodynamic bearing device of FIG. 1.

FIG. 37 is a diagram of a molding device for the sleeve in the hydrodynamic bearing device of FIG. 1.

FIG. 38 is a partial cross-sectional view of the sleeve in the hydrodynamic bearing device of FIG. 1.

FIG. 39 is a diagram illustrating the bearing life of the hydrodynamic bearing device of FIG. 1.

### BEST MODE FOR CARRYING OUT THE INVENTION

Hereinafter, embodiments of the present invention will be described with reference to the drawings.

### Embodiment 1

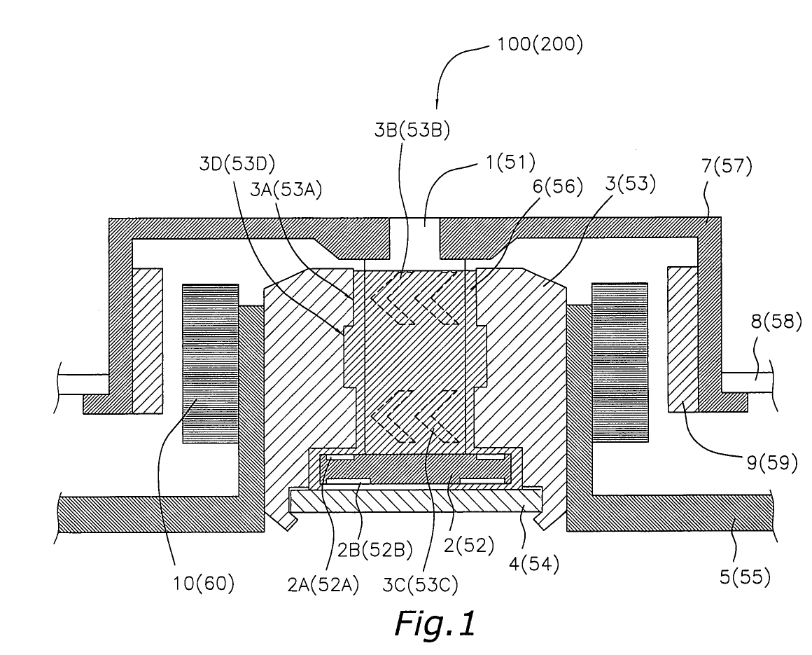

FIGS. 1 through 17 are diagrams showing a structure and a manufacturing method of a hydrodynamic bearing device 100 according to the present invention.

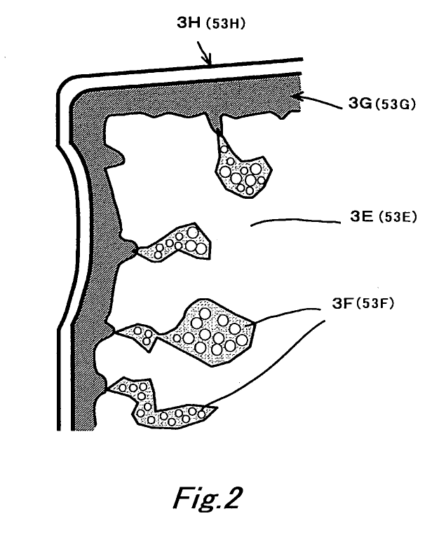

As shown in FIG. 1, the hydrodynamic bearing device 100 includes a shaft 1, a flange 2, a sleeve 3, a thrust plate 4, a lubricating fluid 6, a rotor 7, a disc 8, a rotor magnet 9, a stator 10, and a base 5. The shaft 1 is formed integrally with a flange 2. The shaft 1 is inserted into a bearing hole 3A of the sleeve 3 so as to be rotatable. The flange 2 is accommodated within a recessed portion of the sleeve 3 on a lower surface of the sleeve 3. On at least one of an outer peripheral surface of the shaft 1 and an inner peripheral surface of the sleeve 3, hydrodynamic grooves 3B and 3C (first grooves) are formed. On a surface of the flange 2 which opposes the sleeve 3 and on a surface of the flange 2 which opposes the thrust plate 4, hydrodynamic grooves 2A and 2B are formed. The thrust plate 4 is fixed to the sleeve 3. Bearing gaps near the hydrodynamic grooves 3B, 3C, 2A, and 2B are filled with at least the lubricating fluid 6. The rotor 7 is fixed to the shaft 1. The disc 8 is fixed to the rotor 7 by a damper or the like (not shown). The sleeve 3 includes a large-diameter portion 3D (second groove), which serves as a reservoir for the lubricating fluid. The sleeve 3 is formed of a sintered metal body 3E illustrated by a partial cross-sectional view of FIG. 2. Then, the surface of the sleeve 3 is sealed (step 5) by at least one of the following methods: pores 3F remaining inside the sintered metal body 3E are previously impregnated with a resin, water glass, or the like and the resin or the like is solidified, or injected with a metal having a low melting point such as tin, zinc, or the like at a high temperature and the metal is solidified at a normal temperature as necessary; or a magnetite layer 3G having a thickness of about 1 to 10 micrometers is provided on the surface of the sleeve 3 by a high-temperature steam process at 400 to 700° C. as necessary. Further, on the surface of the sleeve 3, a plating including a nickel content (surface hardening layer) 3H or a DLC hard film (surface hardening layer) 3H having a thickness of 1 to 10 micrometers is formed as necessary (step 6). Since the surface of the sleeve 3 is completely sealed as such, a sleeve cover as in the conventional hydrodynamic bearing device is not required. Furthermore, insufficiency of lubricating fluid because the lubricating fluid flows out from the surface pores does not occur, and also contamination of the surroundings of a hydrodynamic bearing by the flown lubricating fluid 6 being gasified does not occur. As shown in FIG. 1, the sleeve 3 is directly fixed to the base 5 by adhesion or the like without having the sleeve cover 35 interposed therebetween. The rotor magnet 9 is fixed to the rotor 7. The base 5 has a motor stator 10 fixed to a position opposing the rotor magnet 9. Since the sleeve 3 can be directly fixed to the base 5 without having the sleeve cover 35 interposed therebetween, right angle and coaxial angle can be readily secured during assembling and they can be assembled with a high accuracy.

An operation of the hydrodynamic bearing device 100 according to the present invention which has the above-described structure will be described. As shown in FIG. 1, when a rotational magnetic field is generated at the stator 10 by an electronic circuit (not shown), a rotational force is applied to the rotor magnet 9, and the rotor 7, the shaft 1, the flange 2, and the disc 8 start to rotate. The hydrodynamic grooves 3B, 3C, 2A, and 2B gather the lubricating fluid 6 by rotation, and generate pumping pressures between the shaft 1 and the sleeve 3, between the flange 2 and the sleeve 3, and between the flange 2 and the thrust plate 4. In this way, the shaft 1 can rotate in a non-contact state with respect to the sleeve 3 and the thrust plate 4 and data can be recorded/reproduced on/from the disc 8 by a magnetic head or an optical head (not shown). According to the present invention, the hydrodynamic bearing device can be miniaturized since a sleeve cover is not necessary. Furthermore, there is no need to consider about insufficiency of the lubricating fluid because the lubricating fluid flows out from the surface pores, and also contamination of the surroundings of the hydrodynamic bearing device 100 by the flown lubricating fluid 6 being gasified.

(Manufacturing Method of Sleeve 3)

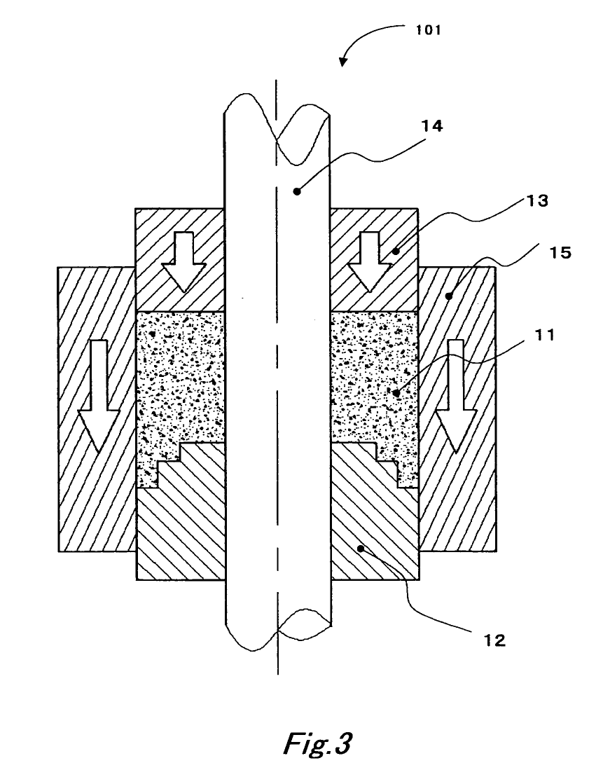

Next, a method for manufacturing the sleeve 3 of the present invention will be described with reference to FIGS. 3 through 15.

FIG. 3 shows a first sizing metal mold 101 for forming a shape of a sintered metal body 11. The first sizing metal mold 101 includes a lower mold 12, an upper mold 13, a pin 14, and an outer mold 15. The sintered metal body 11 is a half-finished product by previously press-forming iron powder or copper powder with a metal mold which is not shown (step 1) and previously sintering the pressed metal powder using a burning furnace which is not shown (step 2). Then, as shown in FIG. 3, the sintered metal body 11 is set on the lower mold 12. The upper mold 13 and the outer mold 15 are moved downward as indicated by arrows in the figure for press-forming.

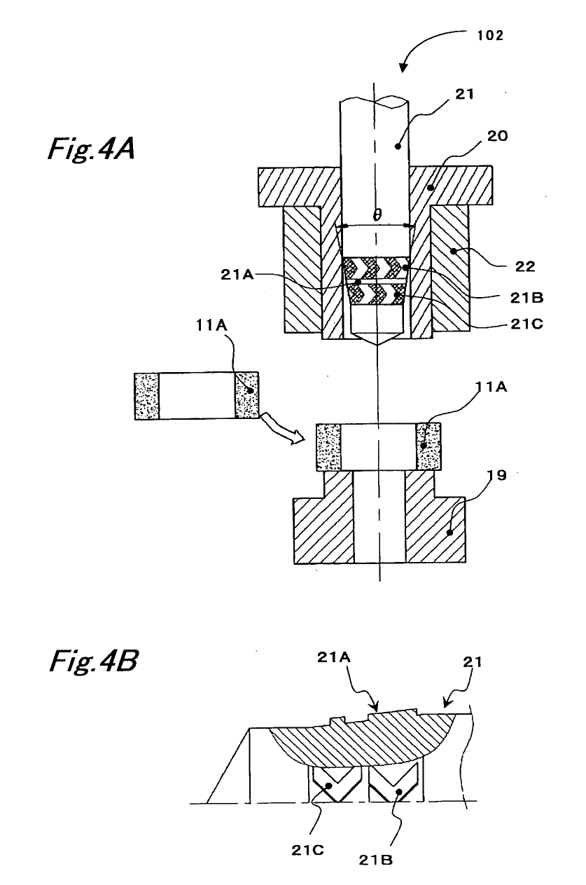

A sintered metal body 11A after the press-forming is treated with the following process (step 3) using a second sizing metal mold 102 as shown in FIGS. 4 through 9. FIG. 4A is a diagram showing a structure of the second sizing metal mold for producing the sleeve 3 (FIG. 1) by processing the hydrodynamic grooves 3B and 3C on the sintered metal body 11A. As shown in FIG. 4A, the second sizing metal mold 102 includes a lower mold 19, an upper mold 20, a core rod 21 (a first core rod), and an outer mold 22. The outer mold 22 is provided coaxially on an external surface of the upper mold 20 so as to be slidable. The core rod 21 is provided coaxially on an inner surface of the upper mold 20 so as to be slidable. On a tapered surface 21A of the core rod 21, recessed portions 21B and 21C of a herringbone pattern are processed to have a uniform depth by using an etching machining method, shot peening method, or the like. Since the hydrodynamic grooves are transferred by the core rod 21, a desired shape for the hydrodynamic grooves which has to be remained as convex portions 21A on the core rod 21. Therefore, as shown in FIG. 4B, recessed portions having a pattern are processed such that the convex portions 21A having the shape of hydrodynamic grooves are left. The bottom surfaces of the recessed portions form an inner peripheral surface of the half-finished sleeve (sleeve under processing) after transferring the pattern. Thus, it is important that the recessed portions have a uniform depth.

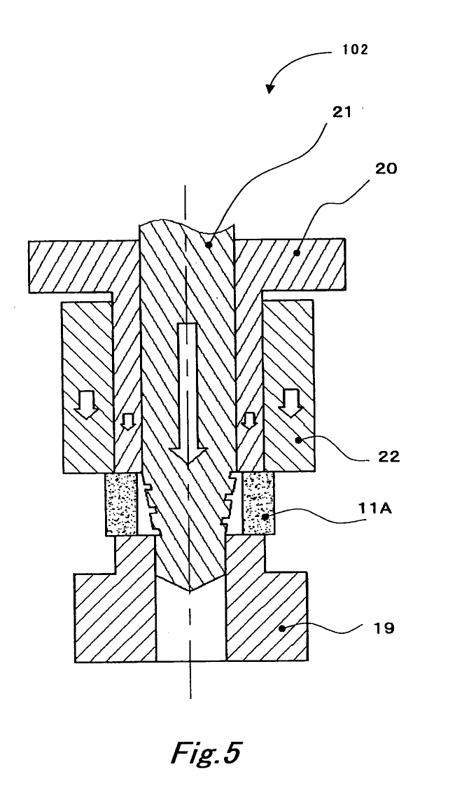

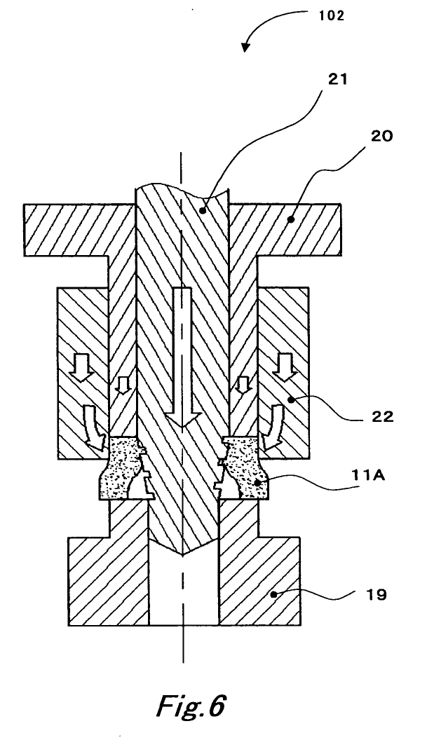

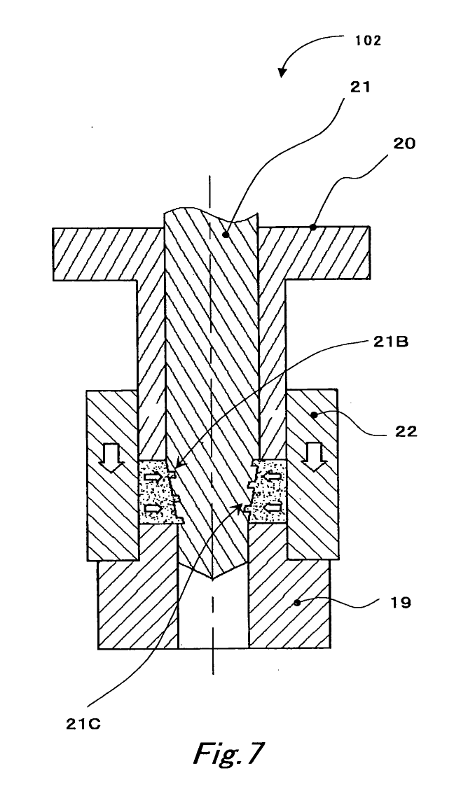

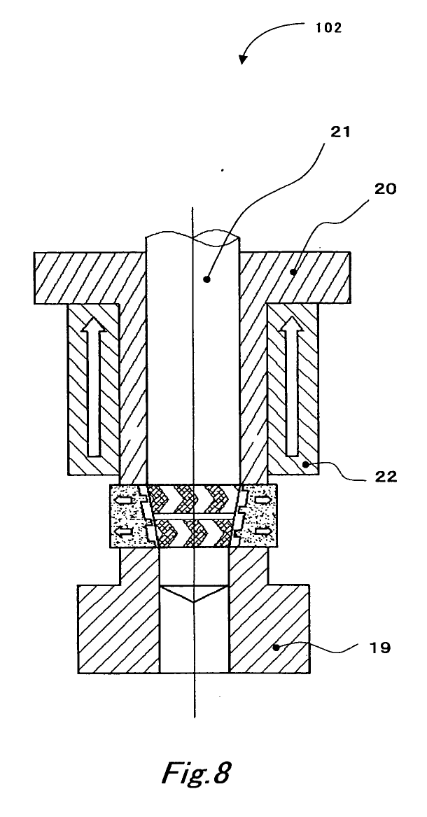

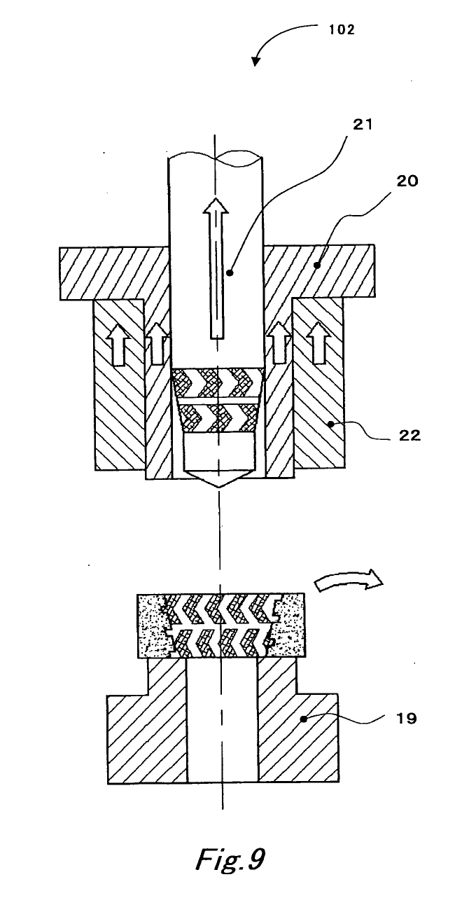

First, as shown in FIG. 4A, the sintered metal material 11A is set on the lower mold 19. Next, as shown in FIG. 5, the upper mold 20 is moved downward as indicated by arrows in the figure to abut the sintered metal material 1A. Then, the core rod 21 is inserted into a bore of the sintered metal material 1A. Thereafter, as shown in FIG. 6, the outer mold 22 is moved downward. When the outer mold 22 is moved downward, it squeezes the sintered metal material 11A with a pressure being applied from an inner surface of the outer mold to an external surface of the sintered metal material 11A. In this way, as shown in FIG. 7, the sintered metal material 11A experiences a plastic flow, and flows into the recessed portions 21B and 21C of the core rod 21 to engage the recessed portions 21B and 21C. Next, as shown in FIG. 8, the outer mold 22 is moved upward, and the inner and outer diameters of the sintered metal material 11A expand respectively by about 2 micrometers due to a springback property. Then, the upper mold 20 is moved upward, and the sintered metal material 11A is removed from the molding device as shown in FIG. 9. Processing the shape, the bearing hole 3A and the hydrodynamic grooves 3B and 3C of the sintered metal material 11A is completed, and the half-finished sleeve is obtained.

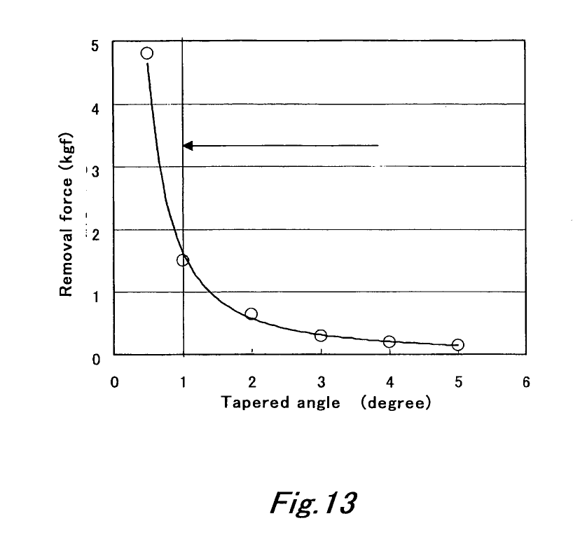

FIG. 13 shows a relationship between a taper angle θ of the tapered surface 21A formed on the core rod 21 and a removal force for removing the core rod 21 in the upward direction as shown in FIG. 9. When the taper angle θ is 1 degree or larger, the core rod 21 can be removed smoothly in the upward direction. The taper angle θ should have a tolerance of plus and minus 1 degrees in the production of mold. Thus, 1 to 3 degrees are suitable as actual degrees.

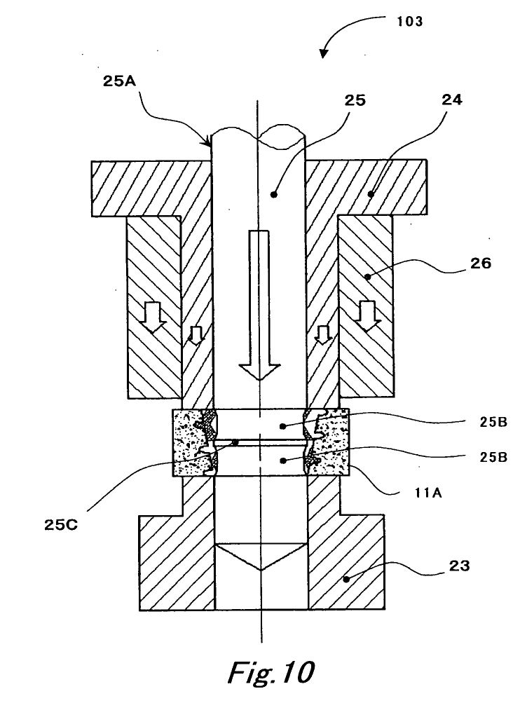

The angle θ of the tapered surface 21 of the core rod 21 is preferably within the range of 1 to 3 degrees. Thus, if a surface tapered by 4 degrees or larger, the tapered shape remaining on the bore cannot be completely altered to a cylindrical shape, which is required, when a finishing process of the inner peripheral surface of the half-finished sleeve is performed using a third sizing metal mold shown in FIGS. 10 to 12. The tapered shape may remain on the surface of the bore of the finished bearing, resulting in low accuracy of the bores.

The half-finished sleeve of the sintered metal material 11A, which is press-formed with a metal mold (not shown) and is sintered, may be treated by a groove rolling process shown in FIG. 4 without performing a process using the first sizing metal mold 101 shown in FIG. 3. However, when the process using the first sizing metal mold 101 shown in FIG. 3 is performed, a variance in dimensions of the bores of the sintered metal body 11A is reduced when the groove rolling process shown in FIG. 4 is performed, and the depth of the hydrodynamic grooves 11E is stabilized.

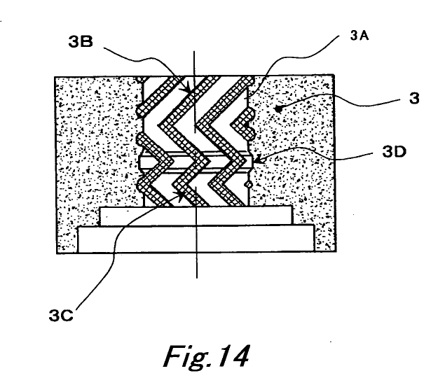

Next, a finishing process for the bore surface of the sintered metal material 11A after the grooves are processed (half-finished sleeve) using the third sizing metal mold shown in FIGS. 10 to 12 and a process for a large-diameter portion 3D for obtaining a function as a reservoir for a lubricating fluid as shown in FIG. 14 (step 4) are performed. As shown in FIG. 10, the third sizing metal mold 103 includes a lower mold 23, an upper mold 24, and a core rod 25 (a second core rod), and an outer mold 26. The outer mold 26 is provided coaxially on an external surface of the upper mold 24 so as to be slidable. The core rod 25 is provided coaxially on an inner of the upper mold 24 so as to be slidable. An outer peripheral surface 25A of the core rod has narrow-diameter portions 25B coaxial with the outer peripheral surface, and a wide-diameter portion 25C which has a diameter substantially same as that of the outer peripheral surface 25A. The narrow-diameter portions 25B are processed by a grinding process or the like to have a smaller diameter by about 2 micrometers. Cylindrical surfaces of the narrow-diameter portions 25B are processed to be smooth cylindrical surfaces with a high accuracy which are required for a metal mold.

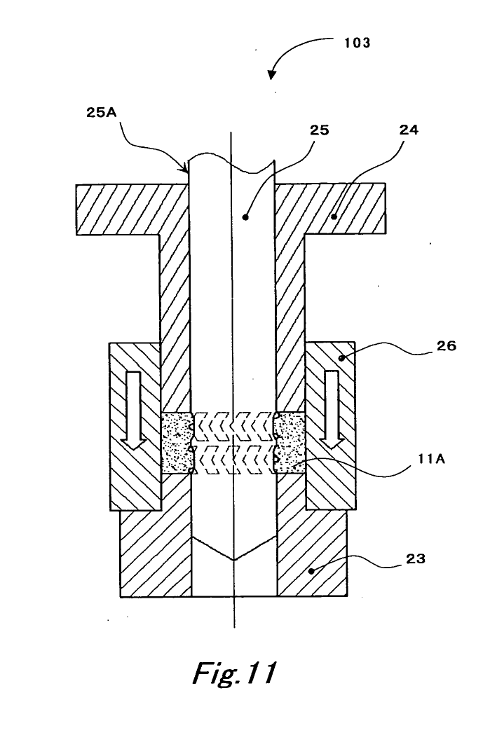

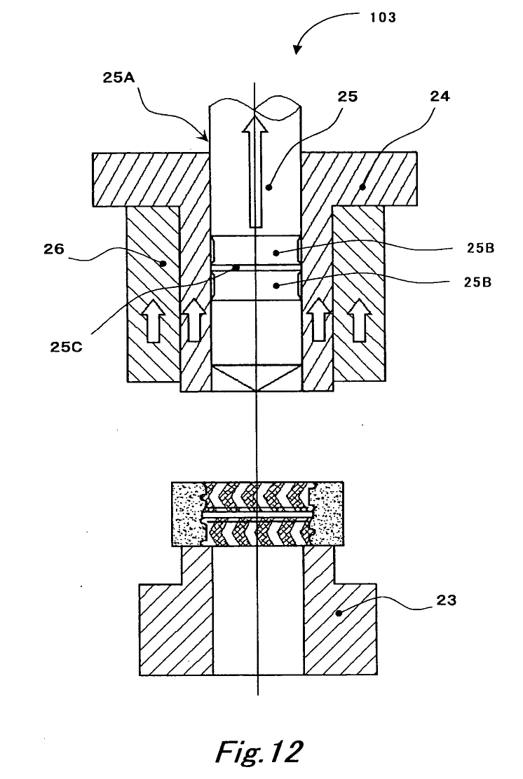

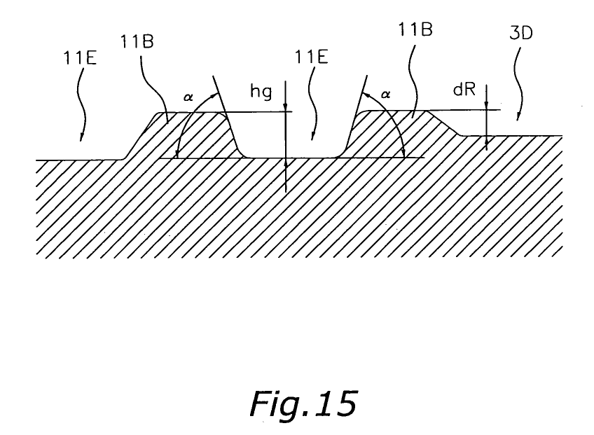

First, as shown in FIG. 10, the sintered metal material 11A with the hydrodynamic grooves 11E processed (half-finished sleeve) is set on the lower mold 23. Next, the upper mold 24 is moved downward as indicated by arrows in the figure to abut the sintered metal material 11A. Then, the core rod 25 is inserted into the bore of the sintered metal material 11A. Thereafter, as shown in FIG. 11, the outer mold 26 is moved downward. When the outer mold 26 is moved downward, it squeezes the sintered metal material 11A with a pressure being applied from an inner surface of the outer mold 26 to the external surface of the sintered metal material 11A. In this way, as shown in FIG. 11, the sintered metal material 11A experiences a plastic flow into the narrow-diameter portions 25B to form the bore surface of the bearing. The wide-diameter portion 25C which has a diameter substantially same as that of the outer peripheral surface 25A of the core rod 25 can form the large diameter portion 3D in the bearing hole 3A of the sintered metal material 11A. The configuration of the hydrodynamic grooves is as illustrated in FIG. 15 and the depth is about 5 micrometers, as indicated by letter hg in FIG. 15 at this point. Letter dR shown in FIG. 15 shows a step portion formed by the wide-diameter portion 25C of the core rod 25, and the height is about 1 micrometer. Herein, the configuration of the groove has a substantially trapezoidal shape as shown in FIG. 15. The angle α of the side surface of the groove with respect to the bottom surface of the groove is 90 degrees or lower. The recessed portion of the core rod 25 is processed by an etching process, or an end mill process. Next, as shown in FIG. 12, the upper mold 24 and the outer mold 22 are moved upward, and the inner and outer diameters of the sintered metal material 11A respectively expand by about 2 micrometers due to a springback property. The core rod 25 and the sintered metal material 11A are separated by a small space. If the core rod 25 is also moved upward at the same time, the sintered metal material 11A can be removed from the third sizing metal mold 103. Processing the shape, the bearing hole 3A and the hydrodynamic grooves 3B and 3C of the sintered metal material 11A is completed, and the sleeve as shown in FIGS. 1 and 14 can be formed.

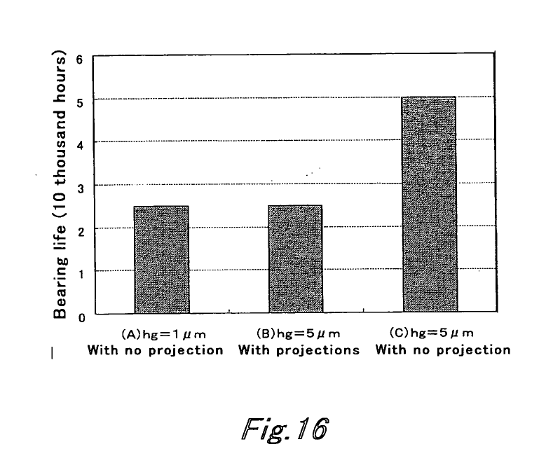

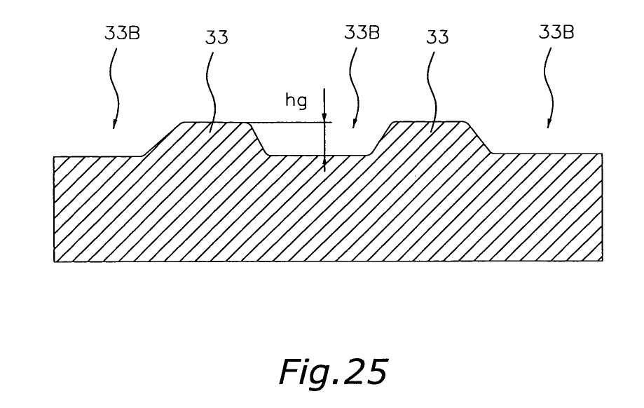

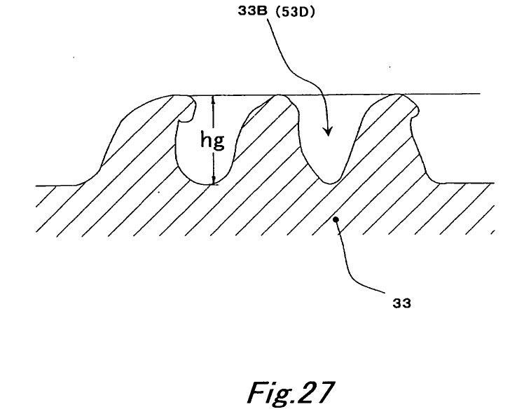

FIG. 16 shows data illustrating a relationship between the configuration of the hydrodynamic grooves 3B and 3C of the sleeve 3 and the life of the bearing of the hydrodynamic bearing device 100 as shown in FIG. 1. According to this experiment, the life of the bearing which has insufficient groove depth hg of 1 micrometer (the groove configuration is same as that shown in FIG. 25), which is denoted by (A) in the figure, and the life of the bearing which has sufficient groove depth hg of 5 micrometers but has the configuration of the hydrodynamic grooves 33b being deformed such that a smooth cylindrical surface is not formed on the bearing surface (the same configuration as that shown in FIG. 27), which is denoted by (B) in the figures, are both about the half of the required life. In the bearing (A) having too shallow hydrodynamic grooves, a pumping force is insufficient, and the performance and the reliability cannot be achieved. In the bearing (B) with the configuration of the hydrodynamic grooves being deformed, the cylindrical surface cannot be formed on the sleeve bearing hole which has to oppose the surface of the shaft. This is assumed as the reason why the pumping pressure is difficult to be generated. As shown in FIG. 16, the hydrodynamic bearing device 100 denoted by (C) which satisfies the conditions of the bearing that groove depth hg is 5 micrometers, which is sufficient, and the groove configuration is maintained as shown in FIG. 15 can achieve a necessary and sufficient bearing life.

A material of the shaft 1 in the present embodiment may be a stainless steel, a high manganese chrome steel, or a carbon steel. A material finished to have a surface roughness within a range of 0.01 to 0.8 micrometers by processing is used for a radial bearing surface of the shaft 1.

In the present embodiment, for obtaining the surface hardening layer 3H of the sleeve 3 shown in FIG. 2, nonelectrolytic plating of a material including nickel and phosphor as main contents is employed. A surface having a hardness of 600 or higher in a Vickers hardness scale is obtained. Alternatively, coating by three dimensional DLC process (Kurita Seisakusho Co., Ltd.) is performed, and a surface having a hardness of 800 or higher in a Vickers hardness scale is obtained. By providing the surface hardening layer 3H with one of these methods, the abrasion-resistant property and the reliability of the hydrodynamic bearing device 100 are improved.

In the sleeve 3 shown in FIG. 2, the pores 3F are impregnated with a thermosetting acrylic resin or anaerobic-setting acrylic resin in a low-pressure bath. These resins are cleaned well before hardening. Thus, a resin attached near surface is completely removed, and only the resin impregnated inside remain and is hardened. This means that, inside the sleeve 3, the pores 3F are sealed with the resin, and the surface of the sleeve 3 is sealed with the magnetite layer (iron oxide film) 3G or the plated layer (surface hardening layer) 3H.

Among the contents of the sleeve 3 shown in FIG. 1, metal powder used for press-forming may be one of coppers, such as brass. However, in order to minimize a gap in the thermal expansion coefficients with the rotary shaft of the motor, iron powder including iron content by 80% by weight, or pure iron is preferable. After the iron powder is press-formed, it is sintered and used as a material of the sintered body for the bearing. In general, the gap between the sleeve 3 and the shaft 1 of the hydrodynamic bearing device 100 is set to be about 2 to 5 micrometers. Factors such as the surface processing accuracy after the pore-sealing process and a gap in use circumstance temperature in thermal expansion coefficient gap in use are important for the hydrodynamic bearing device 100. Further, by employing an iron material as a component of the sleeve 3, a magnetite (Fe₃O₄) film can be readily formed on a porous surface of the press-formed sintered metal material 11A.

Furthermore, the hydrodynamic bearing device 100 of the present embodiment can be applied as a hydrodynamic bearing device shown in FIG. 2 of Japanese Laid-Open Publication No. 2000-197309 (A motor having a Hydrodynamic Bearing and a Recording Disc Driving Device Including the Motor). The hydrodynamic bearing device has a rotor fixed to an upper side of a shaft, and a member of a ring shape attached to a lower side of the shaft, the surroundings of the ring-shaped member includes an oil reservoir adjacent to the radial bearing surface, and a thrust bearing surface is formed with a lower surface of the rotor and an upper surface of the sleeve opposing each other.

The hydrodynamic bearing device 100 of the present embodiment can also be applied to a fluid bearing (not shown) having a shaft-fixed type bearing structure in which the both ends of the shaft are fixed and a sleeve rotate around the shaft.

### Embodiment 2

FIGS. 1, 2, and 29 through 39 are diagrams showing a structure and a manufacturing method of a hydrodynamic bearing device 200 according to the present invention. As shown in FIG. 1, the hydrodynamic bearing device 200 includes a shaft 51, a flange 52, a sleeve 53, a thrust plate 54, a lubricating fluid 56, a rotor 57, a disc 58, a rotor magnet 59, a stator 60, and a base 55. The details of the members having common functions as the members described above in Embodiment 1 will not be described further in this section, and the method for manufacturing the sleeve 53 will be described below.

(Manufacturing Method of Sleeve 53)

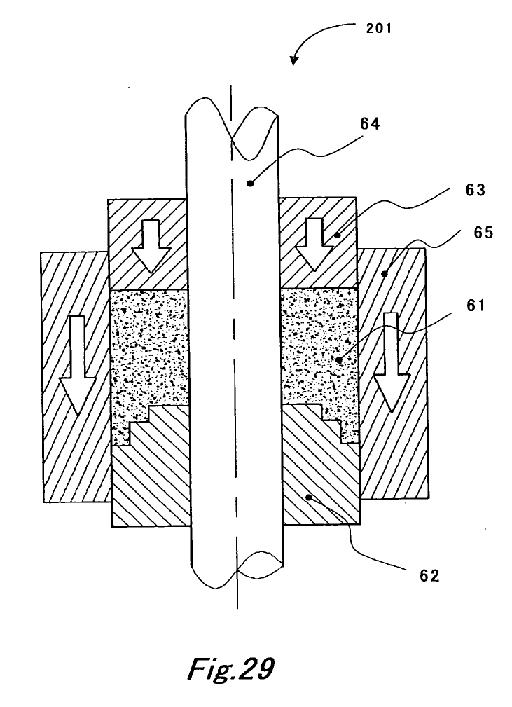

Next, a method for manufacturing the sleeve 53 of the present invention will be described with reference to FIGS. 29 through 39. FIG. 29 shows a fourth sizing metal mold 201 for forming a shape of a sintered metal body 61. The fourth sizing metal mold 201 includes a lower mold 62, an upper mold 63, a pin 64, and an outer mold 65. The sintered metal body 61 is a half-finished product by previously press-forming iron powder or copper powder with a metal mold which is not shown (step 1) and previously sintering the pressed metal powder using a burning furnace which is not shown (step 2). Then, as shown in FIG. 29, the sintered metal body 61 is set on the lower mold 62. The upper mold 63 and the outer mold 65 are moved downward as indicated by arrows in the figure for press-forming.

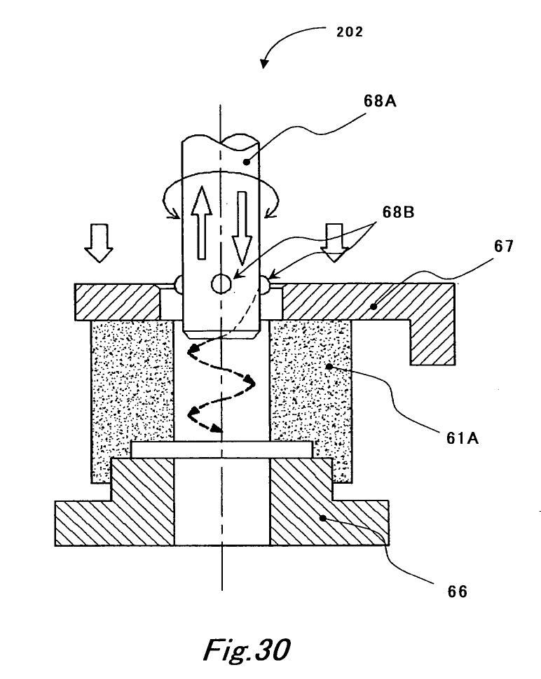

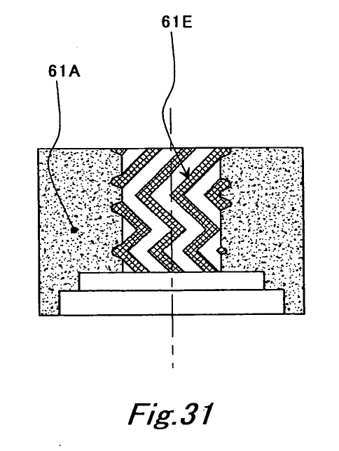

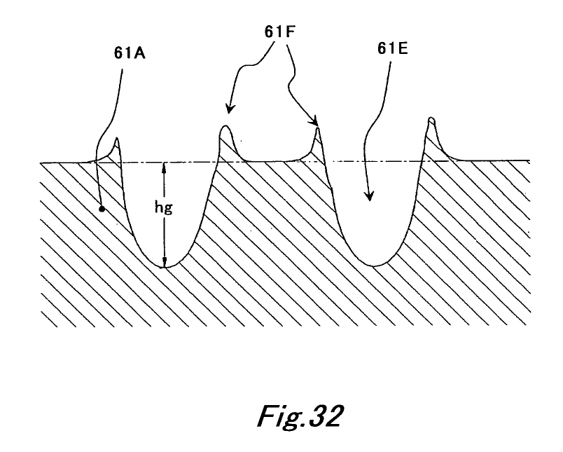

A sintered metal body 61A after the press-forming is treated by a hydrodynamic groove rolling device 202 (step 3) shown in FIG. 30. The sintered metal body 61A after the press-forming is set to an attachment mount 66. A clamp 67 is moved downward as indicated by arrows in the figure and is fixed such that the sintered metal body 61A does not experience a positional shift during the process. A rolling tool formed by integrally providing a plurality of balls 68B on an outer peripheral surface of a shank 68A is press-fitted into a bore of the sintered metal body 61A. By feeding the shank 68A in the upward and the downward directions, the shank 68A rotates in a positive direction and a reversed direction. In this way, the sintered metal body 61A has the hydrodynamic grooves 61E (see FIG. 31) processed by the rolling balls 68B. As shown in FIG. 32, the hydrodynamic grooves 61E have a depth hg of about 10 micrometers. A number of burrs remain around the hydrodynamic grooves 61E. Since the hydrodynamic grooves 61E are formed by the ball rolling as described above, the configuration of the cross sections has substantially an arc shape. Further, bottom surface of the groove and the side surface of the groove of the hydrodynamic grooves 61E have smooth surface because of the surface squeezing effect of the rolling balls 68B to the grooves.

The half-finished sleeve of the sintered metal body 61A, which is press-formed with a metal mold (not shown) and is sintered, may be treated by a groove rolling process shown in FIG. 30 without performing a process using the fourth sizing metal mold 301 shown in FIG. 29. However, when the process using the fourth sizing metal mold 301 shown in FIG. 29 is performed, the variant in dimensions of the bores of the sintered metal body 11A is reduced when the groove rolling process shown in FIG. 4 is performed, and the depth of the hydrodynamic grooves 61E is stabilized.

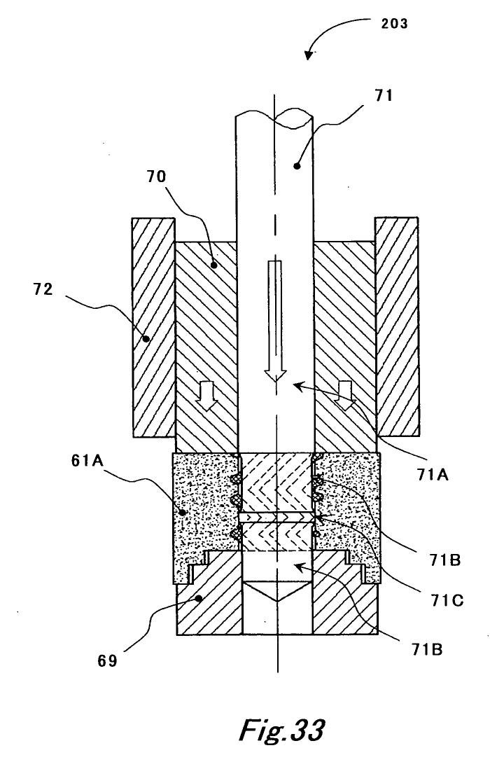

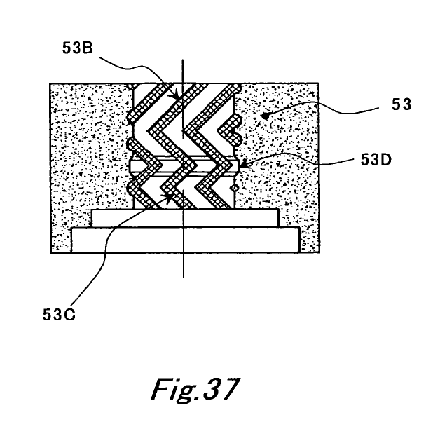

Next, a finishing process for a bore surface of the sintered metal material 61A after the grooves are processed (half-finished sleeve) using the fifth sizing metal mold 203 shown in FIGS. 33 to 36 and a process for a large diameter portion 53D (second groove) for obtaining a function as an oil reservoir as shown in FIG. 37 (step 4) are performed. As shown in FIG. 33, the fifth sizing metal mold 203 includes a lower mold 69, an upper mold 70, a core rod 71 (a second core rod), and an outer mold 72. The outer mold 72 is provided coaxially on an external surface of the upper mold 70 so as to be slidable. The core rod 71 is provided coaxially on an inner of the upper mold 70 so as to be slidable. An outer peripheral surface 71A of the core rod has narrow-diameter portions 71B coaxial with the outer peripheral surface, and a wide-diameter portion 71C which has a diameter substantially same as that of the outer peripheral surface 71A. The narrow-diameter portions 71B are processed by a grinding process or the like to have a smaller diameter by about 2 micrometers. Cylindrical surfaces of the narrow-diameter portions 71B are processed to be smooth cylindrical surfaces with a high accuracy which are required for a metal mold.

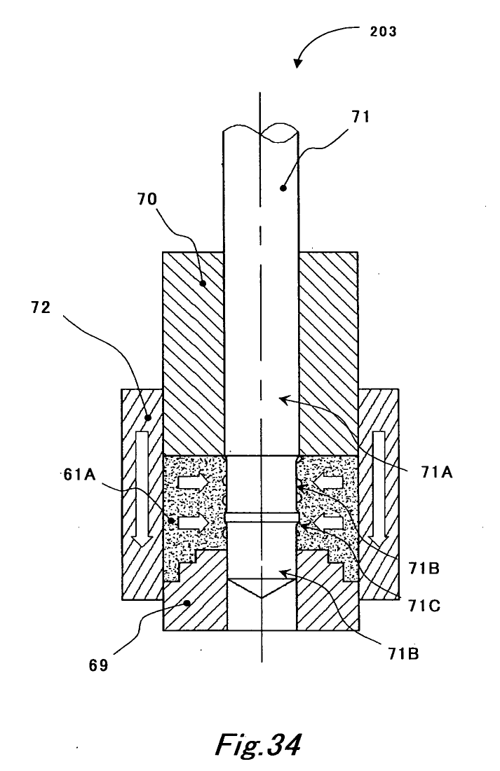

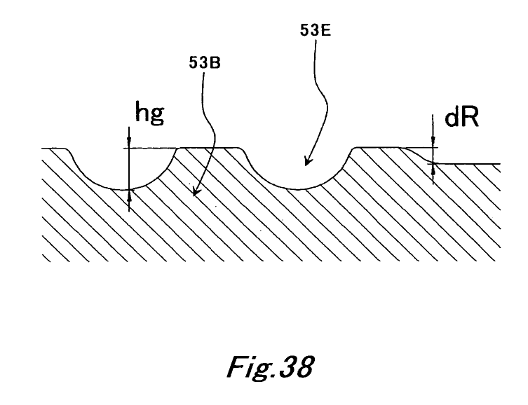

First, as shown in FIG. 33, the sintered metal material 61A with the hydrodynamic grooves 61E processed (half-finished sleeve) is set on the lower mold 69. Next, the upper mold 70 is moved downward as indicated by arrows in the figure to abut the sintered metal material 61A. Then, the core rod 71 is inserted into the bore of the sintered metal material 61A. Thereafter, as shown in FIG. 34, the outer mold 72 is moved downward. When the outer mold 72 is moved downward, it squeezes the sintered metal material 61A with a pressure being applied from an inner surface of the outer mold 72 to the external surface of the sintered metal material 61A. In this way, as shown in FIG. 34, the sintered metal material 61A experiences a plastic flow into the narrow-diameter portions 71B to form the bore surface of the bearing. The wide-diameter portion 71C which has a diameter substantially same as that of the outer peripheral surface 71A of the core rod 71 can form the large diameter portion 53D in the bore of the sintered metal material 61A (see FIG. 37). The configuration of the hydrodynamic grooves is as illustrated in FIG. 38 and the depth is about 5 micrometers, as indicated by letter hg in FIG. 38 at this point. Letter dR shown in FIG. 38 shows a step portion formed by the wide-diameter portion 71C of the core rod 71, and the height is about 1 micrometer.

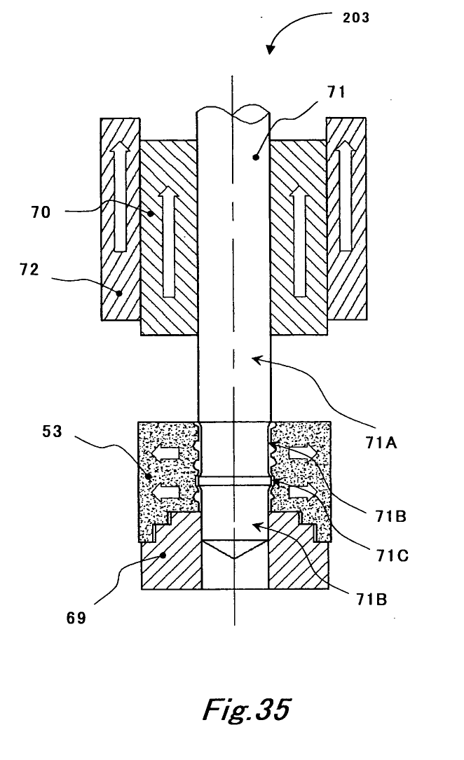

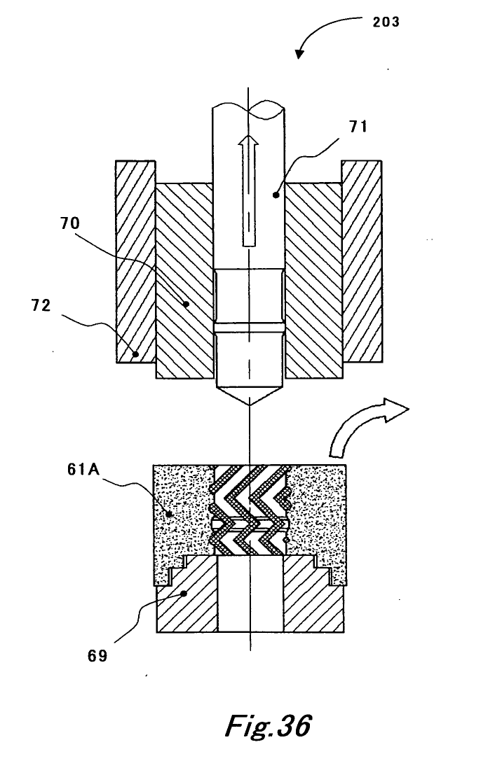

Next, as shown in FIG. 35, the upper mold 70 and the outer mold 72 are moved upward, and the inner and outer diameters of the sintered metal material 61A respectively expand by about 2 micrometers due to a springback property. The core rod 71 and the sintered metal material 61A are separated by a small space. As shown in FIG. 36, when the core rod 71 is moved upward, the sintered metal material 61A can be removed from the fifth sizing metal mold 203. Processing the shape, the bearing hole 53A and the hydrodynamic grooves 53B and 53C (first grooves) of the sintered metal material 61A is completed, and the sleeve as shown in FIGS. 1 and 37 can be formed.

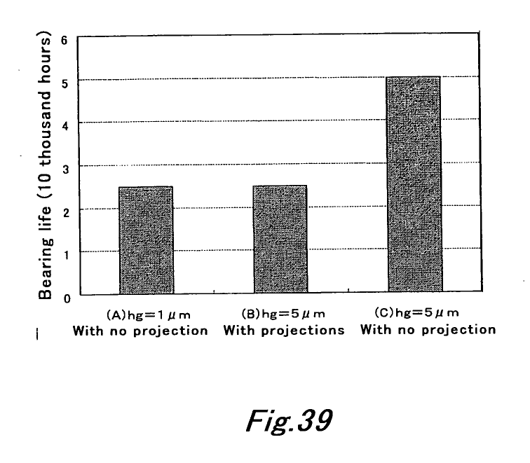

FIG. 39 shows data illustrating a relationship between the configuration of the hydrodynamic grooves 53B and 53C of the sleeve 53 and the life of the bearing of the hydrodynamic bearing device 200 as shown in FIG. 1. According to this experiment, the life of the bearing which has insufficient groove depth hg of 1 micrometer (the groove configuration is same as that shown in FIG. 25), which is denoted by (A) in the figure, and the life of the bearing which has sufficient groove depth hg of 5 micrometers but has the configuration of the hydrodynamic grooves 33B being deformed such that a smooth cylindrical surface is not formed on the bearing surface (the same configuration as that shown in FIG. 27), which is denoted by (B) in the figures, are both about the half of the required life. In the bearing (A) having too shallow hydrodynamic grooves, a pumping force is insufficient, and the performance and the reliability cannot be achieved. In the bearing (B) with the configuration of the hydrodynamic grooves being deformed, the cylindrical surface cannot be formed on the sleeve bearing hole which has to oppose the surface of the shaft. This is assumed as the reason why the pumping pressure is difficult to be generated. As shown in FIG. 38, the hydrodynamic bearing device 200 denoted by (C) which satisfies the conditions of the bearing that groove depth hg is 5 micrometers, which is sufficient, and the groove configuration is maintained as shown in FIG. 36 can achieve a necessary and sufficient bearing life.

As described above, the hydrodynamic groove 53E is formed by ball rolling. Thus, a shape of a cross section of the groove is substantially an arc shape. A flow of the fluid is smooth compared to that in other shapes (for example, a rectangular shape), resulting in good rotation property. Further, surface roughness of a groove bottom surface and groove side surfaces of the hydrodynamic groove 53E formed by ball rolling is smooth because of a surface squeezing effect on the groove surface applied by a rolling ball 68E. The flow of the fluid becomes further smooth, and this also contributes to improvement in the rotation property.

A material of the shaft 51 in the present embodiment may be a stainless steel, a high manganese chrome steel, or a carbon steel. A material finished to have a surface roughness within a range of 0.01 to 0.8 micrometers by processing is used for a radial bearing surface of the shaft 51.

In the present embodiment, for obtaining the surface hardening layer 53H of the sleeve 53, nonelectrolytic plating of a material including nickel and phosphor as main contents is employed. A surface having a hardness of 600 or higher in a Vickers hardness scale is obtained. Alternatively, coating by three dimensional DLC process (Kurita Seisakusho Co., Ltd.) is performed, and a surface having a hardness of 800 or higher in a Vickers hardness scale is obtained. By providing the surface hardening layer 53H with one of these methods, the abrasion-resistant property and the reliability of the hydrodynamic bearing device are improved.

In the sleeve 53 of the present embodiment, the pores 53F are impregnated with a thermosetting acrylic resin or anaerobic-setting acrylic resin in a low-pressure bath. These resins are cleaned well before hardening. Thus, a resin attached near surface is completely removed, and only the resin impregnated inside remain and is hardened. This means that, inside the sleeve, the pores 53F are sealed with the resin, and the surface of the sleeve 3 is sealed with the iron oxide film 53G or the plated layer 53H.

Among the contents of the sleeve 53 shown in FIG. 1, metal powder used for press-forming may be one of coppers, such as brass. However, in order to minimize a gap in the thermal expansion coefficients with the rotary shaft of the motor, iron powder including iron content by 80% by weight, or pure iron is preferable. After the iron powder is press-formed, it is sintered and used as a material of the sintered body for the bearing. In general, the gap between the sleeve 53 and the shaft 51 of the hydrodynamic bearing device 200 is set to be about 2 to 5 micrometers. Factors such as the surface processing accuracy after the pore-sealing process and a gap in use circumstance temperature in thermal expansion coefficient gap in use are important for the hydrodynamic bearing device 200. Further, by employing an iron material as a component of the sleeve 53, a magnetite (Fe₃O₄) film can be readily formed on a porous surface of the press-formed sintered metal material 61A.

Furthermore, the hydrodynamic bearing device 200 of the present embodiment can be applied as a hydrodynamic bearing device shown in FIG. 2 of Japanese Laid-Open Publication No. 2000-197309 (A motor having a Hydrodynamic Bearing and a Recording Disc Driving Device Including the Motor). The hydrodynamic bearing device has a rotor fixed to an upper side of a shaft, and a member of a ring shape attached to a lower side of the shaft, the surroundings of the ring-shaped member includes an oil reservoir adjacent to the radial bearing surface, and a thrust bearing surface is formed with a lower surface of the rotor and an upper surface of the sleeve opposing each other.

The hydrodynamic bearing device 200 of the present embodiment can also be applied to a fluid bearing (not shown) having a shaft-fixed type bearing structure in which the both ends of the shaft are fixed and a sleeve rotate around the shaft.

### Embodiment 3

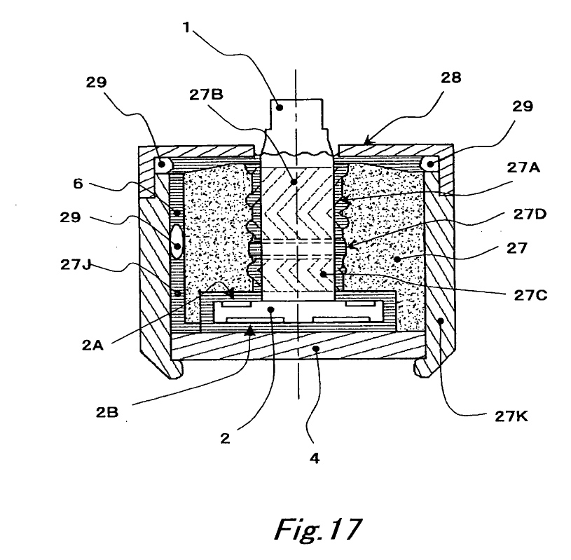

FIG. 17 is a schematic diagram showing a bearing portion of a hydrodynamic bearing device 300 according to Embodiment 3. The hydrodynamic bearing device 300 according to Embodiment 3 includes the shaft 1, the flange 2, a sleeve 27, a bearing hole 23A, hydrodynamic grooves 23B and 23C (first grooves), hydrodynamic grooves 2A and 2B provided on the flange 2, a large diameter portion 23D, a communication hole 23J, and a cap 28.

An operation of the hydrodynamic bearing device 300 according to Embodiment 3 is similar to those of the hydrodynamic bearing device 100 and the hydrodynamic bearing device 300. At least one communication hole 27J is provided on the sleeve 27, and air included in the lubricating fluid 6 in the bearing can be discharged from the communication hole 27J when it expands. With such a structure, bubbles can be prevented from being generated in the hydrodynamic grooves 27B, 27C, 2A, and 2B. An oil film of the lubricating fluid 6 can be securely formed to improve the reliability of the hydrodynamic bearing device.

The communication hole 27J may be processed by a method of drilling a hole in the sleeve 27 formed of a sintered metal body with a drill (not shown). Alternatively, as shown in FIG. 17, the sleeve 27 having a communication hole (communication groove) 27J of a straight groove shape on an outer peripheral surface and a pipe 27K may be formed of sintered metal bodies, and integrated by press-fitting the sleeve 27 into the pipe 27K after sintering with the communication hole 27J being formed at the same time. Then, the second sizing metal mold 102 shown in FIGS. 4 through 9, and the third sizing metal mold 103 shown in FIGS. 10 through 12, for example, may be used for molding. By combining the sleeve 27 and the pipe 27K, the communication hole 27J can be formed with the most inexpensive cost. The communication hole 27J is highly effective for securing the property and the reliability in high-speed rotation of the hydrodynamic bearing device 300. An economic effect of combining two sintered metal bodies to form the communication hole 27J is significant.

The hydrodynamic bearing device 300 has the similar effects as the hydrodynamic bearing device 100 of Embodiment 1 and the hydrodynamic bearing device 200 of Embodiment 2.

### INDUSTRIAL APPLICABILITY

The present invention relates to a hydrodynamic bearing device used for a hard disc device or other devices which has a shaft being inserted into a bearing hole of a sleeve so as to be relatively rotatable, a bearing surface having a hydrodynamic groove in the bearing hole of the sleeve, in which the sleeve is formed by: a first step for forming a metal material by forming metal powder to have a hollow cylindrical shape; a second step for sintering the metal material; a third step for inserting a first core rod having a tapered surface and recessed portions in a pattern or protruding portions having a hydrodynamic groove pattern on the tapered surface into a bore of a sintered metal material, forming hydrodynamic grooves by pressing from upper, lower and side surfaces, and removing the first core rod to form a half-finished sleeve with the hydrodynamic grooves; and a fourth step for inserting a second core rod having a wide diameter portion and a narrow diameter portion into the half-finished sleeve, and pressing from upper, lower and side surfaces to form a bearing inner surface having a hydrodynamic groove with the small diameter portion of the second core rod, forming a large diameter portion on the inner peripheral surface of the sleeve with the wide diameter portion of the second core rod, and removing the second core rod to form the sleeve.

Further, a hydrodynamic bearing device has a shaft being inserted into a bearing hole of a sleeve so as to be relatively rotatable, a bearing surface having a hydrodynamic groove in the bearing hole of the sleeve, in which the sleeve is formed by: a first step for forming a metal material by forming metal powder to have a hollow cylindrical shape; a second step for sintering the metal material; a third step for forming the hydrodynamic groove on an inner peripheral surface of the sintered metal material by rolling; and a fourth step for inserting a core rod having a wide diameter portion and a narrow diameter portion into the sintered metal material, and pressing from upper, lower and side surfaces to form a bearing inner surface having a hydrodynamic groove with the small diameter portion of the core rod, forming a large diameter portion on the inner peripheral surface of the sleeve with the wide diameter portion of the core rod, and removing the core rod to form the sleeve.

The inner periphery formed as such serves as the bearing inner surface and a large diameter portion of the sleeve serves as a lubricating fluid reservoir. Thus, grooves can be processed with a high accuracy. A hydrodynamic bearing with a high performance and long life without pressure leakage and a manufacturing method thereof can be achieved.

1. A hydrodynamic bearing device, comprising:
a shaft;
a sleeve formed of sintered metal which has a bearing hole with the shaft being inserted into the bearing hole so as to be relatively rotatable; and
a lubricating fluid held between the shaft and the sleeve,
wherein, on an inner peripheral surface of the bearing hole, a second groove which forms a lubricating fluid reservoir, and a first groove which forms a hydrodynamic portion having a depth greater than that of the second groove and a cross section of a substantially trapezoidal shape are formed.

2. A hydrodynamic bearing device according to claim 1, wherein a surface of the sleeve is impregnated with a resin or water glass to seal pores on the surface.

3. A hydrodynamic bearing device according to claim 1, wherein a surface of the sleeve is impregnated with metal molten by heating to seal pores on the surface.

4. A hydrodynamic bearing device according to claim 1, wherein an oxide film is formed on a surface of the sleeve to seal pores on the surface.

5. A hydrodynamic bearing device according to claim 1, wherein a thin film is formed on a surface of the sleeve by plating metal including nickel.

6. A hydrodynamic bearing device according to claim 1, wherein a thin film is formed a surface of the sleeve by DLC coating.

7. A spindle motor, comprising:
a hydrodynamic bearing device according to claim 1;
a hub which is fixed to the hydrodynamic bearing device, and which allows the hydrodynamic bearing device to rotate;
a magnet fixed to the hub;
a base plate for fixing the hydrodynamic bearing device; and
a stator fixed to the base plate so as to oppose the magnet.

8. A method for manufacturing a hydrodynamic bearing device having a shaft, a bearing hole having a hydrodynamic groove on an inner peripheral surface, and a sleeve having the shaft inserted into the bearing hole so as to be relatively rotatable, comprising:
a first step for forming a first compact by forming metal powder to have a hollow cylindrical shape;
a second step for sintering the first compact;
a third step for inserting a first core rod having a tapered surface and recessed portions in a pattern on the tapered surface into a bore of a second compact obtained by sintering at the second step, forming hydrodynamic grooves with the recessed portions formed on the tapered surface by pressing from upper, lower and side surfaces, and removing the first core rod to form a half-finished sleeve with the hydrodynamic grooves; and
a fourth step for inserting a second core rod having a wide diameter portion and a narrow diameter portion into the half-finished sleeve, and pressing from upper, lower and side surfaces to form a bearing inner surface having a hydrodynamic groove, which is a first groove, with the small diameter portion of the second core rod, forming a second groove of a large diameter portion on the inner peripheral surface of the sleeve with the wide diameter portion of the second core rod, and removing the second core rod to form the sleeve.

9. A method for manufacturing a hydrodynamic bearing device according to claim 8, wherein the tapered surface of the second core rod has a tapered angle of 1 to 3 degrees.

10. A method for manufacturing a hydrodynamic bearing device according to claim 8, further comprising a fifth step for sealing a surface of the sleeve with at least one of the following methods: impregnating the surface of the sleeve with a resin or water glass, impregnating metal molten by heating; or forming an oxide film on the surface of the sleeve.

11. A method for manufacturing a hydrodynamic bearing device according to claim 8, further comprising a sixth step for forming a thin film by plating metal including nickel or by DLC coating on a surface of the sleeve.

12. A hydrodynamic bearing device, comprising:
a shaft;
a sleeve formed of sintered metal which has a bearing hole with the shaft being inserted into the bearing hole so as to be relatively rotatable; and
a lubricating fluid held between the shaft and the sleeve,
wherein, on an inner peripheral surface of the bearing hole, a second groove which forms a lubricating fluid reservoir, and a first groove which forms a hydrodynamic portion having a depth greater than that of the second groove and a cross section of a substantially arc shape are formed.

13. A hydrodynamic bearing device according to claim 12, wherein a surface of the sleeve is impregnated with a resin or water glass to seal pores on the surface.

14. A hydrodynamic bearing device according to claim 12, wherein a surface of the sleeve is impregnated with metal molten by heating to seal pores on the surface.

15. A hydrodynamic bearing device according to claim 12, wherein an oxide film is formed on a surface of the sleeve to seal pores on the surface.

16. A hydrodynamic bearing device according to claim 12, wherein a thin film is formed on a surface of the sleeve by plating metal including nickel.

17. A hydrodynamic bearing device according to claim 12, wherein a thin film is formed a surface of the sleeve by DLC coating.

18. A spindle motor, comprising:
a hydrodynamic bearing device according to claim 12;
a hub which is fixed to the hydrodynamic bearing device, and which allows the hydrodynamic bearing device to rotate;
a magnet fixed to the hub;
a base plate for fixing the hydrodynamic bearing device; and
a stator fixed to the base plate so as to oppose the magnet.

19. A method for manufacturing a hydrodynamic bearing device having a shaft, a bearing hole having a hydrodynamic groove on an inner peripheral surface, and a sleeve having the shaft inserted into the bearing hole so as to be relatively rotatable, comprising:
a first step for forming a first compact by forming metal powder to have a hollow cylindrical shape;
a second step for sintering the first compact;
a third step for forming a first groove of the hydrodynamic groove by rolling on an inner surface of a second compact obtained by sintering in the second step; and
a fourth step for inserting a core rod having a wide diameter portion and a narrow diameter portion into the second compact, and pressing from upper, lower and side surfaces to form a bearing inner surface of the of a first groove which has a hydrodynamic groove with the small diameter portion of the core rod, forming a second groove of a large diameter portion on the inner peripheral surface of the sleeve with the wide diameter portion of the core rod, and removing the core rod to form the sleeve.

20. A method for manufacturing a hydrodynamic bearing device according to claim 19, further comprising a fifth step for sealing a surface of the sleeve with at least one of the following methods: impregnating the surface of the sleeve with a resin or water glass, impregnating metal molten by heating; or forming an oxide film on the surface of the sleeve.

21. A method for manufacturing a hydrodynamic bearing device according to claim 19, further comprising a sixth step for forming a thin film by plating metal including nickel or by DLC coating on a surface of the sleeve.
